(19) United States
(12) Patent Application Publication
(10) Pub. No.: US 2022/0234895 A1
(43) Pub. Date: Jul. 28, 2022

(54) THREE-DIMENSIONAL CARBON NANOTUBE SPONGE MATERIALS AS ABSORBERS OF PHASE CHANGE MATERIALS

(71) Applicant: CSS NANOTECH, LLC, Houston, TX (US)

(72) Inventor: Daniel P. Hashim, Houston, TX (US)

(21) Appl. No.: 17/611,101

(22) PCT Filed: May 13, 2020
(86) PCT No.: PCT/US20/32658

§ 371 Date: Nov. 12, 2021

Related U.S. Application Data
(60) Provisional application No. 62/847,443, filed on May 14, 2019.

(51) Int. Cl. C01B 32/168; C09K 5/06

(52) U.S. Cl. CPC C01B 32/168; C01P 2002/54; C09K 5/066

(57) ABSTRACT

Composite materials comprising a phase change material (PCM) and a macroscale 3D carbon nanotube material, such as a macroscale 3D heteroatom-doped carbon nanotube material, including boron doped carbon nanotube materials, and methods for using the composite materials in various applications where temperature control is critical. Heteroatom-doped carbon nanotube sponge materials are strongly oleophilic, and can soak up large quantities of organic PCMs. One representative application for the composite materials is in thermal energy storage (TES) systems for shipping and storage of pharmaceuticals, medical and life science products.

### FIELD OF THE INVENTION

The present invention relates to composite materials where a phase change material (PCM), preferably an organic PCM, is present in the pores of a porous, oleophilic, three-dimensional (3D) carbon nanotube macroscale foam as sponge-like materials. These materials can be used in a variety of thermal energy storage (TES) applications, specifically including applications related to thermal packaging system designs for transporting valuable temperature-sensitive cargo for the cold-chain logistics industry. With TES systems, cargo such as biotechnology and pharmaceutical products or biological substances such as food or blood can be transported while maintaining an appropriately low temperature to avoid product degradation.

### BACKGROUND OF THE INVENTION

Phase change materials (PCMs) store and release large amounts of energy, in the form of latent heat. While phase changes can occur among any combination of the three phases of a substance, that is, gas, liquid, or solid, the most commercially viable transition is between liquid and solid phases. A PCM in its solid phase absorbs heat, providing a cooling effect, and a PCM in its liquid phase releases heat, providing a warming effect.

PCMs are used in a variety of applications, including medical applications, applications in the building and construction industry, aerospace applications, energy applications, and the like. There are specific desired thermal, physical, kinetic and chemical properties when PCMs are used. From a thermal point of view, a suitable phase change temperature range, a high latent heat of fusion and a good heat transfer towards the PCM are preferred.

There are many types of PCMs, including alkanes, alcohols, organic acids, esters, polyethylene glycols, inorganic salt hydrates, mixtures of inorganic salts and/or inorganic hydrates, eutectic mixtures of organic-organic materials, eutectic mixtures of organic-inorganic materials, and eutectic mixtures of inorganic-inorganic materials. Some PCMs are biodegradable, bio-based PCMs, and others are traditional petroleum-based PCMs.

Because PCMs melt, and the liquid PCM would tend to flow away from where it is needed, PCMs are typically encapsulated, whether by microencapsulation or macroencapsulation. However, efforts have been made to form composite PCMs where a PCM is encapsulated in a porous material.

By way of example, polyethylene glycol (PEG) is a potentially promising solid-liquid PCM, because of its excellent properties, such as a high phase change enthalpy, good chemical properties, bio-degradation, non-toxicity, excellent resistance to corrosion, a lack of decomposition within its melting/freezing temperature range, and a relatively competitive price. However, PEG suffers from poor macroscopic stability and poor thermal conductivity (Zalba, et al., “Review on thermal energy storage with phase change: Materials, heat transfer analysis and applications,” Appl. Therm. Eng., 23, 251-283 (2003); Li, et al., “Simultaneous enhancement of latent heat and thermal conductivity of docosane-based phase change material in the presence of spongy graphene,” Sol. Energy Mater. Sol. Cells 128, 48-51 (2014)).

To overcome the problem of PEG leakage during the solid-liquid phase change process, different materials have been used to encapsulate PEG, including polymeric materials, metals, and porous materials. Porous materials can effectively prevent PEG leakage due to their high porosity and large specific surface area.

Carbon aerogels have been used to prepare supporting frames for some PCMs, due to their high adsorption and porosity, which enables them to provide a suitable sealing structure to control the leakage of composite PCMs. Recently, Yang prepared PCMs of PEG with a cellulose/GNP frame, and they purportedly had good shape stability and high thermal conductivity (Yang, et al., “Cellulose/graphene aerogel supported phase change composites with high thermal conductivity and good shape stability for thermal energy storage,” Carbon, 98, 50-57 (2016)). One author provided a hybrid carbon foam (CF) by ultrasonication of an aqueous dispersion of graphene oxide (GO) and carbon nanotubes (CNTs) (Su et al., “A Unique Strategy for Polyethylene Glycol/Hybrid Carbon Foam Phase Change Materials: Morphologies, Thermal Properties, and Energy Storage Behavior,” Materials 2018, 11 (2011)). This foam was used as a supporting frame for composite PCMs of PEG. GO provided a “skeleton” to control liquid leakage during the phase change, and the CNTs served as a bridge to improve the thermal conductivity of the composite PCMs.

It would be advantageous to provide additional porous materials in which to encapsulate PCMs, particularly where the porous materials provide relatively high thermal conductivity, and composite materials including PCMs encapsulated in these porous materials.

### SUMMARY OF THE INVENTION

In one embodiment, composite materials comprising phase change materials (PCMs) encapsulated in macroscale three-dimensional carbon nanostructure porous foams as sponge-like materials are disclosed.

In one embodiment, the three-dimensional carbon nanostructure porous foam comprises one or more carbon nanomaterial elements, such as nanotubes, graphene, graphite microtubes or microfibers, or combinations thereof. In one aspect of this embodiment, these carbon nanomaterial elements are doped, for example, with one or more heteroatoms, such as boron, sulfur, nitrogen, or phosphorous. In another aspect, these carbon nanomaterial elements are un-doped, that is, left in their pristine carbon form. In another aspect, the porous foam comprises combinations of doped and un-doped elements.

The carbon nanotube elements can be single-walled, double-walled, or multi-walled. The graphene elements can be single-layer, double-layer, multi-layer structures. The three-dimensional carbon nanostructure porous foam can be made in various ways, all of which are within the scope and spirit of the present teachings, and any specifically listed renderings should only be considered as examples for illustrative purposes.

In one embodiment, the three-dimensional carbon nanostructure porous foam is synthesized using a catalytic chemical vapor deposition (CVD) process. An exemplary CVD processes includes Aerosol-Assisted Chemical Vapor Deposition (AA-CVD).

In another embodiment, the three-dimensional carbon nanostructure porous foams are synthesized via other methods. Representative methods include freeze-drying processes, where individual carbon nano-scaled elements are mixed with solvents and then subjected to freeze drying, pyrolysis of polymers or other organic materials, and/or electro-spinning processes. In some aspects, the three-dimensional carbon nanostructure porous foam comprises carbon nanostructures obtained from various exfoliation methods, including graphene exfoliation.

In one embodiment, composite materials comprising phase change materials (PCMs) encapsulated in macroscale three-dimensional carbon nanotube structures are disclosed. In one aspect of this embodiment, the three-dimensional carbon nanotube structures include one or more heteroatoms, such as boron, sulfur, nitrogen, or phosphorous. These heteroatoms can be incorporated into the three-dimensional carbon nanotube structures, for example, by using them as dopants in a synthesis process, which forms heteroatom-doped carbon nanotube materials, such as boron-doped carbon nanotube (“CBxNT”) materials.

Herein, with respect to doping with heteroatoms, the term “doping” refers to placing heteroatoms in the CNT lattice in place of carbon atoms. A “heteroatom-doped CNT” is a carbon nanotube that has heteroatoms replacing carbon atoms in the CNT lattice.

The carbon nanotube materials can be prepared, for example, using the techniques disclosed in U.S. Publication No. 20120238021 by Daniel Paul Hashim, the contents of which are hereby incorporated by reference for all purposes. U.S. Publication No. 20120238021 discloses how to exploit the uniqueness of heteroatom substitutional dopant effects on CNT morphology to create elastic macroscale 3D structures. In combination with the heteroatoms (such as boron atoms) interstitial “welding” and “surfactant” effects, the doping route is directed to true (covalent) macroscale 3D carbon nanotubes, such as CNT monoliths, or interlocked nanotube ring structures.

The substitutional doping effects of boron, and/or other heteroatoms such as sulfur, nitrogen, phosphorus, and the like, in carbon nanotubes creates a networked CBxNT solid (when the heteroatom is boron), which is a macroscale 3D material). These materials possess chemical and mechanical properties which allow them to serve as a support for PCMs.

In one aspect, an abundance of localized and topological defects, including extreme tubular morphologies, are impactful features for applications requiring further CNT functionalization chemistry, or anchor-sites for molecular/atomic/nanoparticle adsorption (decoration) within the 3D porous solid. Furthermore, substitutionally-doped CNTs provide enhanced chemical reactivity.

In one aspect, macroscopic three-dimensionally networked CBxNT materials (or other heteroatom-doped carbon nanotube materials) are directly grown using an aerosol-assisted chemical vapor deposition method. The resulting porous nanotube sponge is created by doping boron and/or other heteroatoms in the nanotube lattice during growth, which influences the creation of elbow joints and branching of nanotubes leading to the three-dimensional super-structure. The resulting materials have unique properties. For instance, the super-hydrophobic CBxNT material is strongly oleophilic, and can therefore soak up large quantities of organic PCMs. Due to this property, the CBxNT materials are sometimes referred to herein as “CBxNT sponges” or “CBxNT sponge-like materials.” The trapped PCM can melt and re-solidify repeatedly without the PCM leaking out when it is melted, making the CBxNT sponges” an ideal scaffold for organic PCMs. This is not to say that the CBxNT sponges cannot be used with other types of PCMs, just that they are ideally suited for organic PCMs.

The CBxNT sponges can be grown in a macroscale (cm³ in size) manner which forms 3D networked heteroatom-doped carbon nanotube materials (such as CBxNT materials), for example, using AACVD synthetic processes, which can be performed at relatively large scales, in a relatively efficient manner.

Detailed elemental analysis of the CBxNT sponges revealed the heteroatom (such as boron) to be responsible for these results and creates “elbow-like” junctions and covalent nanojunctions. These observations are in agreement with first principle calculations—indicating that the most suitable sites to host heteroatoms within a defective sp²-hybridized carbon network are close to heptagonal rings or negatively curved areas. These macroscale 3D heteroatom-doped carbon nanotube frameworks contain many functional defect-sites, which can be an advantage over pristine carbon nanotube counterparts. To this end, heteroatom-doped carbon nanotubes can function as selective sorbent materials, particularly for organic PCMs.

The synthesis of the CBxNT sponges can be controlled to provide materials with a range of densities and porosities. In some embodiments, lightweight or ultra-lightweight (having a density <10 mg/cc) macroscale 3D materials are provided, which exhibit a variety of multi-functional properties including robust elastic mechanical properties, including thermal stability, high porosity, super-hydrophobicity, and oleophilic behavior, which makes them ideal supports for organic PCMs.

In one aspect, the method of making macroscale 3D heteroatom-doped carbon nanotube materials involves first forming a chemical precursor solution comprising a carbon source, a catalyst source, and a heteroatom source. An aerosol is generated from the chemical precursor solution, which is used in an aerosol-assisted chemical vapor deposition process to form the macroscale 3D heteroatom-doped carbon nanotube material. The macroscale 3D heteroatom-doped carbon nanotube material include heteroatom-doped carbon nanotubes.

In some embodiments, the heteroatom is boron. The heteroatom-doped carbon nanotubes can include two-dimensional heteroatom-doped carbon nanotubes. Representative carbon sources include both gas and/or liquid sources, including, but not limited to, toluene, cyclohexane, heptane, pentane, xylenes, hexanes, benzene, and combinations thereof. The carbon source can include a liquid hydrocarbon that is capable of dissolving the catalyst source, the heteroatom source, or both.

In one embodiment, the carbon source is at least 87 wt % of the carbon source, the catalyst source, and the heteroatom source in the chemical precursor solution, for example, between about 87 wt % and about 97 wt % of the carbon source, the catalyst source, and the heteroatom source in the chemical precursor solution.

The catalyst source catalyzes the formation of carbon nanotubes in a chemical vapor deposition process. The catalyst source can include a metal catalyst, such as iron, nickel, cobalt, alloys thereof, and combinations thereof, wherein iron is a preferred metal, and metallocenes, such as ferrocene, nickelocene, cobaltocene, and combinations thereof, are preferred catalyst sources.

In one embodiment, the catalyst source is between about 2.5 wt % and about 12 wt % of the carbon source, the catalyst source, and the heteroatom source in the chemical precursor solution, for example, between about 2.5 wt % and about 10 wt % of the carbon source, the catalyst source, and the heteroatom source in the chemical precursor solution.

The heteroatom can include boron, sulfur, nitrogen, phosphorus, or a combination thereof. The heteroatom source can be a boron source, a sulfur source, a nitrogen source, a phosphorus source, or a combination thereof.

Boron sources include boron trichloride (BCl₃), organoboranes, organoborates, and combinations thereof. Representative boron sources include, but are not limited to, trimethylborane, triphenylborane, trimesitylborane, tributylborane, triethylborane, boric acid, trimethyl borate, triisopropylborate, triethyl borate, triphenyl borate, tributyl borate, diethylmethoxyborane, and combinations thereof.

The heteroatom source can include a sulfur source, and representative sulfur sources include, but are not limited to, amorphous sulfur powder, thiophene, allyl sulfide, allyl methyl sulfide, dibenzothiophene, diphenyl disulfide, and combinations thereof.

In one embodiment, the heteroatom source is at most about 2 wt % of the carbon source, the catalyst source, and the heteroatom source in the chemical precursor solution, for example, between about 0.1 wt % and about 2 wt % of the carbon source, the catalyst source, and the heteroatom source in the chemical precursor solution.

The catalyst source can include metal atoms. The heteroatom source can include heteroatoms. In one aspect, the ratio of the metal atoms to the heteroatoms is between 2 and 20, more typically, between 4 and 6.

The chemical precursor solution can be prepared, for example, by mixing the carbon source, catalyst source, and heteroatom source, and sonicating the resulting mixture. The aerosol can be introduced into a reactor capable of performing the aerosol-assisted chemical vapor deposition process using the aerosol to form the heteroatom-doped carbon nanotube material. The aerosol can be introduced into the reactor, for example, via a carrier gas stream, such as argon or argon/hydrogen balanced gas. The carrier gas stream can be introduced into the reactor at a gas flux range between about 0.05 sl/min-cm² and about 0.6 L/min-cm². The reactor can include a horizontal quartz hot-wall reactor chamber. In one aspect, the aerosol-assisted chemical vapor deposition process is carried out under atmospheric pressure and at a temperature between 800° C. and 900° C.

In one aspect, the method further comprises welding the heteroatom-doped carbon nanotubes in the heteroatom-doped carbon nanotube material, for example, using microwave and/or ultrasonication

In one embodiment, the method further comprises forming a composite material that includes the macroscale 3D heteroatom-doped carbon nanotube material and a PCM. In one aspect, the PCM is introduced into the material in the molten state, for example, using vacuum impregnation.

In various aspects:

a) the bulk density of the macroscale 3D heteroatom-doped carbon nanotube material is between 10 mg/cm³ and 29 mg/cm³, is <10 mg/cm³ or is >29 mg/cm³.

b) the average diameter of the heteroatom-doped carbon nanotubes in the heteroatom-doped carbon nanotube material is between 40 nm and 150 nm,

c) the heteroatom-doped carbon nanotube material is essentially heteroatom-doped carbon nanotubes with little to no trace of amorphous carbon,

d) the heteroatom-doped carbon nanotubes have heteroatom induced elbow defects,

e) the heteroatom-doped carbon nanotube material have a weight-to-weight absorption capacity between about 22 and about 123,

f) the macroscale 3D heteroatom-doped carbon nanotube material is capable of absorbing a volume of PCM that is between about 70% and about 115% of the volume of the macroscale 3D heteroatom-doped carbon nanotube material before absorbing the PCM,

g) the macroscale 3D heteroatom-doped carbon nanotube material can be magnetic.

h) at least some of the macroscale 3D heteroatom-doped carbon nanotubes are functionalized, and/or

i) the heteroatom is boron, sulfur, nitrogen, phosphorus, or a combination thereof.

The macroscale 3D heteroatom-doped carbon nanotube material can be made by the process including the steps of:

a) forming a chemical precursor comprising a carbon source, a catalyst source, and a heteroatom source;

b) generating an aerosol or vapor from the chemical precursor; and

c) performing a chemical vapor deposition process using the aerosol or vapor to form the macroscale 3D heteroatom-doped carbon nanotube material.

The macroscale 3D heteroatom-doped carbon nanotube material is impregnated with a PCM, such as an organic PCM, and used in applications where PCMs are typically used. In one embodiment, the use involves transportation and/or storage of medical and life science products. Additional uses include operating tables, hot-cold therapies, treatment of birth asphyxia, solar cooking, cold energy batteries, temperature control in buildings, electrical engines, green houses, and food products, delaying ice and frost formation on surfaces, waste heat recovery, off-peak power utilization, heating and cooling water, heat pump systems, passive storage in bioclimatic building/architecture, smoothing exothermic temperature peaks in chemical reactions, solar power plants, spacecraft thermal systems, thermal comfort in vehicles, thermal protection of electronic devices, thermal protection of food, textiles used in clothing, computer cooling, turbine inlet chilling with thermal energy storage, and telecom shelters in tropical regions.

In some embodiments, it is desirable to remove the PCM in the macroscale 3D carbon material, such as a 3D heteroatom-doped carbon nanotube material. The PCM can be removed from the macroscale 3D carbon nanotube material, such as macroscale heteroatom-doped carbon nanotubes, for example, by burning the PCM, by evaporating the PCM, by melting the PCM and using negative pressure (i.e., a vacuum) to remove it from the material, or by extraction. The macroscale 3D heterodoped carbon nanotube materials can then be reused with a different PCM, for example, to provide a composite material with a different phase transition temperature.

Applying three-dimensional carbon nanostructure sponges (a.k.a., nanosponge) or foams as an absorber of PCMs can result in significant benefits, for example, in the cold-chain pharmaceutical packaging industry. A 3-D carbon nanostructure-PCM composite material realizes the benefits of having a solid-solid PCM material for thermal packaging designs all while maintaining the advantages of the high latent heats commonly known to solid-liquid PCMs. Relative to solid-liquid PCM materials, a nanosponge-PCM can allow for more uniform thermal payload, which in turn provides for more consistent protection and deters the possibility of leakage that sometimes occurs with pure liquid PCMs.

Carbon nanosponge-PCM composite materials can allow for a greater degree of flexibility to simplify design challenges. One advantage provided by the composite materials is that they allow for a “leak-proof” design, and also allow for maximum packing of the thermal payload of solid-liquid PCMs. Nanosponge foams can potentially replace or otherwise limit the need for bulky Styrofoam or styrene-based insulation in thermal packaging systems.

In some embodiments, carbon-nanomaterial-based foams (sponges) offer one or more advantages over typical polymer-based foams (sponges) for this application. These advantages may include one or more of the following:

Carbon nanomaterials (e.g. carbon nanotubes and graphene) have much better thermal properties (lower thermal resistance and higher thermal conductivity than most materials and especially that of PCMs which are known to possess very low thermal conductivities) and much higher surface area (as compared to the use of any polymer-based sponge materials) to more efficiently transfer thermal energy out of the PCMs when cooling or “charging” the system. This can allow for far more efficient cooling rates of the PCM. Within the support of a high surface area and highly uniform 3D carbon nano-scale porous framework, the material will act as a nucleation surface to facilitate the liquid-solid transition mechanism to deter the negative effects of supercooling (when the PCM stays in a liquid state well below its freezing temperature). The supercooled liquid phase is disadvantageous in a PCM's functionality, as its application choice is to take advantage of its latent heat release as oppose to the sensible heat release of the supercooled liquid state which doesn't maintain its constant low temperature upon heating and will be problematic for temperature distribution uniformity. Thus, it is desirable to facilitate the liquid-solid transition during cooling of PCMs to take advantage of the latent heat properties of the PCM in order to allow temperature uniformity, and the nanosponge-PCM composite can assure this phase change transition even at the most extreme (rapid) cooling rates.

Carbon-nanomaterial-based foams (sponges) typically possess much higher porosity (as high as >99%) and lower density than polymer foams. This can allow for relatively more volume to fill with the PCM, which, in turn, can provide a significantly higher payload, which translates into a longer duration of temperature control within a given temperature range.

In some embodiments, carbon-nanomaterial-based foams (sponges) have a relatively lower density than polymer foams, which can provide superior specific absorption capacity to maximize the payload, while adding minimal weight to the system.

The carbon-nanomaterial-based foams (sponges) also tend to have relatively smaller pore sizes and relatively higher surface area than polymer sponges. Accordingly, they can more effectively retain the PCMs, with optimal uniformity, and lessen the possibility of leakage when the PCM melts, thus offering a “leak proof” design.

Carbon-nanomaterial-based foams (sponges) offer far superior chemical stability than polymer foams, and will not corrode/degrade over time even in the harshest of solvents. This can allow for fewer design limitation constraints with respect to the choice of PCM. By way of example, certain PCMs are linear hydrocarbons, and others are esters or alcohols. Such PCMs, when melted, can potentially dissolve certain polymer foams, but will not dissolve the carbon-nanomaterial-based foams (sponges).

Carbon-nanomaterial-based foams (sponges) exhibit temperature invariant viscoelasticity, which allows for relatively consistent flexibility with temperature changes. This is in contrast to polymer foams, which exhibit glass transition temperatures and dramatic changes in their viscoelasticity.

### DESCRIPTION OF DRAWINGS

For a more detailed understanding of the preferred embodiments, reference is made to the accompanying figures, wherein:

FIG. 1A is a photographic image of macroscale 3D CBxNT material, produced using the methods described herein.

FIG. 1B is a photographic image of the macroscale 3D CBxNT material of FIG. 1A showing its flexibility and mechanical stability upon being bent by hand.

FIG. 1C is an SEM image of an ion beam slice of the macroscale 3D CBxNT material after ion beam slice and view feature showing that the interior porous structure. The scale is 10 μm.

FIG. 1D is an SEM image showing a magnified view of the “elbow” defects found in CBxNTs of the CBxNT material. The scale is 200 μm.

FIG. 1E is an STEM image showing two, four-way covalent nanojunctions in series of the CBxNT material. The scale is 200 μm.

FIG. 1F is a TEM image showing two overlapping CBxNT's (in the CBxNT material) welded together assisted by boron doping. The scale is 10 μm.

FIG. 2A is a photograph of macroscale 3D CBxNT material taken under sunlight.

FIG. 2B is another photograph of macroscale 3D CBxNT material taken under sunlight.

FIG. 2C is a photograph of macroscale 3D CBxNT material taken on the contoured shape of a 1-inch diameter quartz tube in a reaction chamber.

FIG. 2D is another photograph of macroscale 3D CBxNT material taken on the contoured shape of a 1-inch diameter quartz tube in a reaction chamber.

FIG. 2E is a photograph showing a water droplet 201 that beaded-up on contact with the surface of the CBxNT material, which is indicative of the super-hydrophobicity of the CBxNT material.

FIG. 3A is an x-ray diffraction pattern of a sample of macroscale 3D CBXNT material.

FIG. 3B is an x-ray diffraction pattern of a sample of pristine (undoped) carbon nanotube material.

FIG. 3C is a graph of the weight-to-weight absorption capacity defined by the ratio of (a) the final weight after solvent absorption to (b) the initial weight of the sponge before absorption for common solvents, as measured on CBXNT material samples having different densities. Lines 1301-1303 are for CBXNT material samples having densities of 24.3 mg/cm³, 17.3 mg/cm³, and 10.8 mg/cm³, respectively.

FIG. 4 is a graph showing the variation in temperature with energy provided to a PCM. Notice the region where the temperature is held constant during the latent heat transition where the PCM undergoes the solid-liquid phase change whereas in the other regions you see the PCM act as a sensible heat storage material.

FIG. 5 shows the melting enthalpy and melting temperature ranges for polymeric SS-PCMs.

FIG. 6 shows the enthalpy and temperature ranges for SL-PCMs and SS-PCMs; L-PCMs: (1) Water-salt solutions; (2) Water; (3) Clathrates; (4) Paraffins; (5) Salt hydrates; (6) Sugar alcohols; (7) Nitrates; (8) Hydroxides; (9) Chlorides; (10) Carbonates; (11) Fluorides; (12) Polymeric; SS-PCMS: (12) Polymeric; (13) Organics (Polyols); (14) Organometallics; (15) Inorganics (Metallics).

FIG. 7 shows an example TES packaging design comprising (1) outer corrugated cardboard box, (2) molded EPS shipper container base, (3) PCM pouches, (4) product box (tertiary container) and (5) molded EPS shipper container lid.

### DETAILED DESCRIPTION

In one embodiment, composite materials comprising heteroatom-doped carbon nanotube materials, such as CBxNT materials (or CBxNT sponges), and PCMs are disclosed. Throughout the present specification, boron-doped carbon materials are primarily discussed. However, this is representative of doping carbon nanotubes with other heteroatoms, such as sulfur or nitrogen.

While there is no limitation on the types of PCMs that can be used, organic PCMs can be preferred, as the CBxNT sponges are hydrophobic and oleophilic.

The composite materials can be used in a variety of applications. The particular application depends, at least in part, on the phase transition temperature of the PCM incorporated into the CBxNT sponges.

The CBxNT sponges, and methods for making them, PCMs and their phase transition temperatures, methods for making the composite materials, and uses for the composite materials, are described in more detail below.

### I. Synthesis of CBxNT Sponges

The CBxNT sponges can be prepared, for example, using relatively large-scale CVD synthesis methods, such as aerosol-assisted CVD (AACVD) synthesis, using boron as a heteroatom.

When a specific ratio of carbon source, catalyst source, and boron source is used in the process, the result is formation of “elbow” tubule morphologies, which in turn forms sponge-like macroscale 3D materials of entangled carbon nanotube networks.

While not wishing to be bound by a particular theory, it is believed that the heteroatom (i.e., boron) was responsible for the formation of these “elbow” defects, which evidences structural morphology effects of substitutional doping with foreign atoms in the pristine carbon nanotube lattice. The resulting heteroatom-doped carbon nanotube macroscopic porous sponge-like material (for example, the CBxNT sponge) exhibits robust isotropic elastic mechanical properties, high electrical conductivity, high porosity, super-hydrophobicity, oleophilic behavior, and strong magnetism. The high porosity, super-hydrophobicity, and oleophilic behavior enable the CBxNT nanosponge to be used as a carrier for PCMs, particularly organic PCMs, for use in all applications where PCMs are used.

The following are representative precursor formulas and experimental parameters/processing conditions, to be used with chemical vapor deposition, such as AACVD, form the CBxNT sponge materials described herein, or analogous materials where the heteroatom is other than boron.

In some embodiments, the CBxNT sponge invention is synthesized via an aerosol assisted CVD technique. Representative process steps include:

(a) Forming the heteroatom-doped carbon nanotube macroscopic porous material (i.e., the CBxNT sponge or analogous materials where the heteroatom is other than boron);

(b) Optionally characterizing the heteroatom doped carbon nanotube material;

(c) Optionally functionalizing the heteroatom-doped carbon nanotube material;

(d) Forming composites of the heteroatom-doped carbon nanotube material and an encapsulated PCM; and

(e) Using the composite materials in applications where phase change materials are commonly used.

Synthesis of the Heteroatom Doped Carbon Nanotube Material

In some embodiments, the heteroatom-doped carbon nanotube synthesis takes advantage of the doping effect of heteroatoms (such as boron) on tubule morphology in order to create the three-dimensional entangled networked heteroatom-doped carbon nanotube materials (such as macroscale 3D CBxNT porous materials).

In an embodiment, CBxNT material (multi-walled carbon nanotubes) are grown directly on the walls of a quartz tube furnace via a chemical vapor deposition (CVD) method, and, more specifically, an aerosol-assisted chemical vapor deposition (AACVD), using triethylborane (TEB) (Aldrich >95%) as the boron source.

The AACVD process can be carried out under atmospheric pressure conditions and can include a horizontal quartz hot-wall reactor chamber heated by a tube furnace in the temperature range of 800-900° C. The process involves using chemical precursor solutions that include a carbon source, a catalyst source, and a heteroatom source (such as a boron source).

Representative carbon sources include organic liquid (solvent) sources and is generally an aromatic hydrocarbon, such as toluene (C₇H₈) or cyclohexane (C₆H₁₂). Other carbon sources include heptane (C₇H₁₆), pentane (C₅H₁₂), xylenes (C₈H₁₀), hexanes (C₆H₁₄), and benzene (C₆H₆). Toluene is a good carbon source to use, as it is also a solvent in which the other components of the chemical precursor solution can be dissolved. Generally, the carbon source is above 87% of the total weight of the carbon source, the catalyst source, and the heteroatom source in the chemical precursor solutions. In some embodiments, the chemical precursor solutions can be prepared using between about 92 wt % and about 97 wt % of toluene as the carbon source.

The catalyst source is generally a metal catalyst source, such as a metallocene in solid powder form. Typically, the metal catalyst source is an iron metal catalyst source, such as ferrocene (C₁₀H₁₀Fe). Other metal catalyst sources include nickel metal catalyst sources, such as nickelocene (C₁₀H₁₀Ni), and cobalt metal catalyst sources, such as cobaltocene (C₁₀H₁₀Co), and combinations/alloys thereof.

In embodiments utilizing a metallocene, the metallocene (solid powder) concentration dissolved in the hydrocarbon (liquid) is generally between 10 to 150 mg/mL. For instance, ferrocene (solid) concentration dissolved in the toluene (liquid) is generally between 10 to 150 mg/mL.

Generally, the catalyst source is between 2.5 and 12 wt % of the total weight of the carbon source, the catalyst source, and the heteroatom source in the chemical precursor solutions. In some embodiments, the chemical precursor solutions can be prepared using between about 2.5 and about 10 wt % of ferrocene as the catalyst source.

Representative heteroatom sources include liquid, solid, and gas sources. When the materials are prepared using AACVD, the heteroatom source is generally a liquid, or one which dissolves in the chemical precursor solution. For example, when the heteroatom is boron, representative boron sources include organoboranes and organoborates. Representative organoboranes include triethylborane (Aldrich>95%) (TEB) (C₆H₁₄B), trimethylborane (liquid) (C₆H₁₄B), triphenylborane (solid) (C₁₈H₁₅B), trimesitylborane (solid) (C₂₇H₃₃B), tributylborane (liquid) (C₁₂H₂₇B), and triethylborane. Representative organoborates include boric acid, trimethyl borate, triisopropylborate, triethyl borate, triphenyl borate, tributyl borate, and diethylmethoxyborane. An example of a gas source may be Boron trichloride (BCl₃), and in some aspects, is mixed with a carrier gas.

Also, for example, when the heteroatom is sulfur, the sulfur source is sulfur containing organic compound. The sulfur source can be pure amorphous sulfur powder or sulfur containing organic compound such as thiophene, allyl sulfide, allyl methyl sulfide, dibenzothiophene, or diphenyl disulfide.

Generally, the heteroatom source is less than about 2 wt % of the total weight of the carbon source, the catalyst source, and the heteroatom source in the chemical precursor solutions. In some embodiments, the chemical precursor solutions can be prepared using between about 0.1 and about 1.0 wt % of triethylborane (Aldrich>95%) (TEB) as the boron source.

In some embodiments of the present invention, the chemical precursor solutions were prepared using 87-96.9 wt. % toluene as the carbon source, 2.5-12 wt. % ferrocene as the iron metal catalyst source and concentrations varying between 0.1-2.0 wt. % triethylborane (Aldrich>95%) (TEB) as the boron source. These concentrations of the carbon source, a catalyst source, and the boron source in the chemical precursor solutions can be varied depending on the desired properties of the material, such as density, porosity, surface area, carbon nanotube diameter, boron doping concentration, etc.

In some embodiments, the Fe:B, Ni:B, or Co:B (Fe:S, Ni:S, or Co:S) molar ratio within the solution (or gas mixture) is between 2 to 20, and typically between 4 and 6.

After mixing the carbon source, the catalyst source, and the boron (or other heteroatom) source together, this mixture can optionally be sonicated, such as to speed up the dissolution of the catalyst source and/or the boron source in the chemical precursor solution. The sonication can occur between about 15 minutes and an hour. Typically, the sonication occurs for around 30 minutes or more.

After preparation, the chemical precursor solution is placed in an aerosol generator to generate an aerosol, (i.e., micro-droplet (<10 micron diameter) size mist cloud). For instance, an ultrasonic generator can be used to produce an ultrasonic beam directed at the surface of the chemical precursor solution, which forms the aerosol. Such aerosol can be then transported to the reactor by flow of a carrier gas, such as argon (or other non-reactive gas). Examples of such ultrasonic aerosol generators include the Pyrosol 7901 type manufactures by RBI Instrumentation. The Pyrosol 7901 type generator is a vessel with an ultrasonic piezoelectric transducer film at the bottom, controlled by an external generator with adjustable frequency and amplitude. During this aerosol generation process, the aerosol is generated above the solution.

Other types of aerosol generators include ones that are injection systems similar to those utilized in the automobile industry. The chemical precursor solution is stored in a tank, and then pushed under a pressure (typically around 1 bar) by a carrier gas, such as argon, to a valve working in a pulsed mode.

After generation, the aerosol is transferred into the reactor chamber using a carrier gas, such as argon. In some embodiments, the carrier gas is introduced into the reactor at a gas flux range between about 0.05 standard liters per minute per square centimeter (sl/min-cm²) and about 0.6 sl/min-cm², and typically between about 0.20 sl/min-cm² and about 0.30 ml/min-cm². Thus, a range of flux values can be used to determine the carrier gas feed rate that scales into the CVD system. For instance, when the gas flow of the carrier gas is through a 4.6 cm inner diameter tube (such as a 4.6 cm inner diameter quartz tube), a carrier gas flux of 0.24 sl/min-cm² would yield a solution feed rate of 4.0 sl/min-cm². Again, the carrier gas is typically argon. In some embodiments, the carrier gas can be an argon-hydrogen gas mixture.

Referring to the precursor solution in carrier gas, the precursor solution can be introduced into the reactor at a gas flux range between about 0.01 ml/min-cm² and about 0.5 ml/min-cm², and typically between about 0.09 ml/min-cm² and about 0.15 ml/min-cm². Again, the range of flux values can be used to determine the solution feed rate that scales into the CVD system. For instance, when the gas flow of the carrier gas is through a 4.6 cm inner diameter tube (such as a 4.6 cm inner diameter quartz tube), a solution flux of 0.09 ml/min-cm² would yield a solution feed rate of 1.50 ml/min.

In the hot chamber reactor zone, the chemical precursor solution is evaporated and the heteroatom-doped carbon nanotube material (such as CBxNT material) is either prepared and collected on the wall of the reactor or is deposited and grown on a substrate, which, in some embodiments, is a metal foil substrate, such as aluminum, or tin foil. Typically, the heteroatom-doped carbon nanotube growth occurs on quartz/silica substrate in a quartz tube furnace.

One advantage of using an AACVD process is that the chemical precursor can be continuously fed into the reactor chamber, thus rendering the process commercially scalable.

For example, a three-dimensional (3D) bulk CBxNT material consisting entirely of CBxNTs was synthesized as follows:

The aerosol-assisted chemical vapor deposition (AACVD) system was carried out under atmospheric pressure conditions and comprises a horizontal hot-wall quartz tube reactor chamber heated by a furnace (30 cm heating zone). Solutions were prepared mixing toluene (Aldrich, anhydrous, 99.8%) and ferrocene (Fe(C₅H₅)²) (Alpha Aecer 99%) at a concentration of 25 mg/mL, and triethylborane (TEB) ((C₂H₅)₃B) (Aldrich>95%) at Fe:B ratio 5:1, followed by 30-minute sonication. The TEB was added while in a glove box under an inert nitrogen atmosphere.

The chemical precursor solution was placed in a glass vessel with an ultrasonic piezoelectric transducer film (diameter=40 mm) at the bottom (Pyrosol 7901 type). The piezoelectric frequency and amplitude was controlled by an external generator source providing a resonant frequency about 0.8 MHz.

The chemical precursor solution feed rate was varied between 0.4-0.8 ml/min for a total synthesis time of 30 minutes. The aerosol generated above the solution was transferred into the reactor chamber by an argon, or argon/hydrogen balanced, carrier gas (argon/hydrogen balanced gas is preferred) at flow rates of 2.00-2.50 L/min. The furnace temperature ranged from 850° C.-870° C. in the chamber reactor zone where the chemical precursor solution was evaporated. The temperature of the furnace may range from 800 to 900° C., but is usually between 840 to 870° C. and more usually between 850° C. and 860° C.

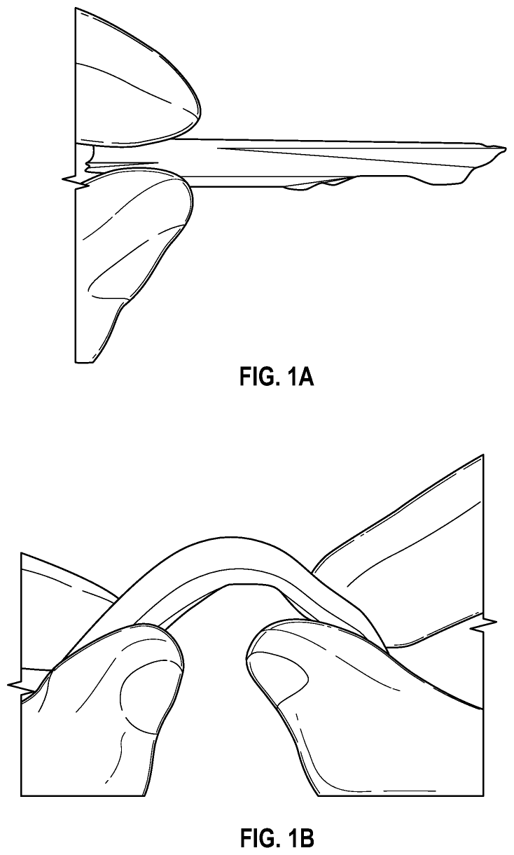

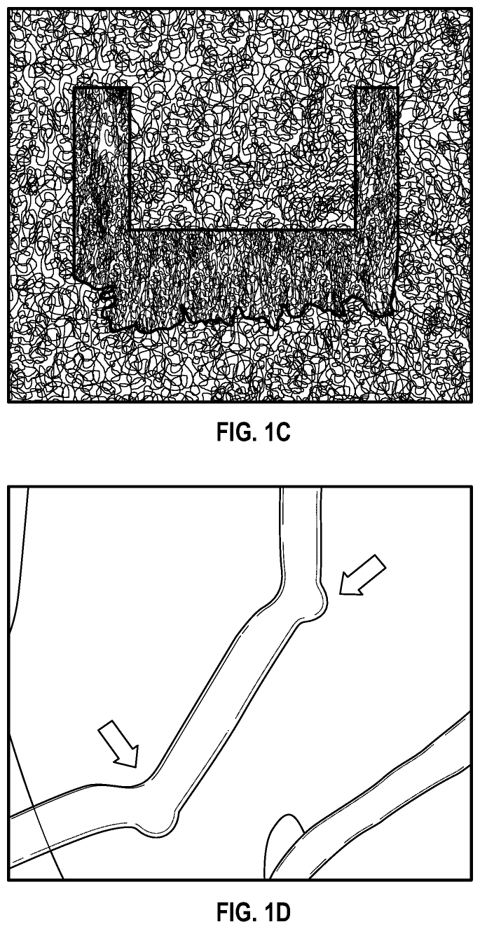

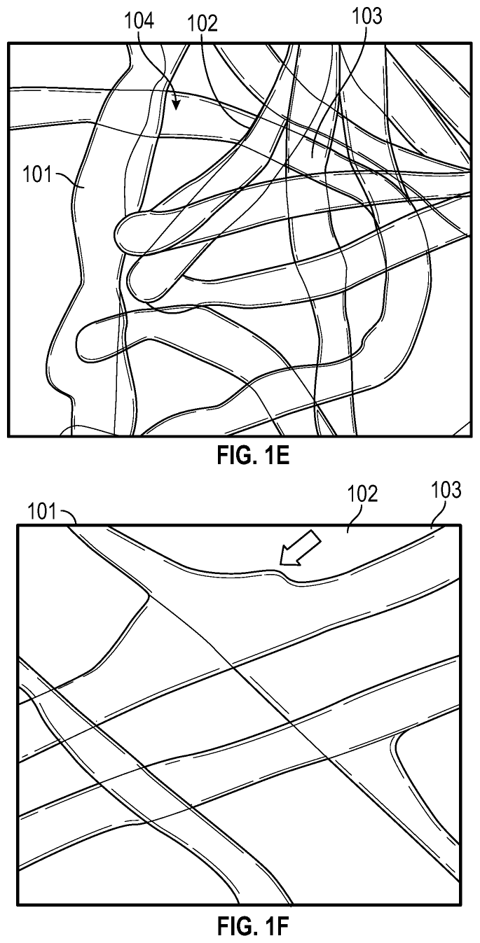

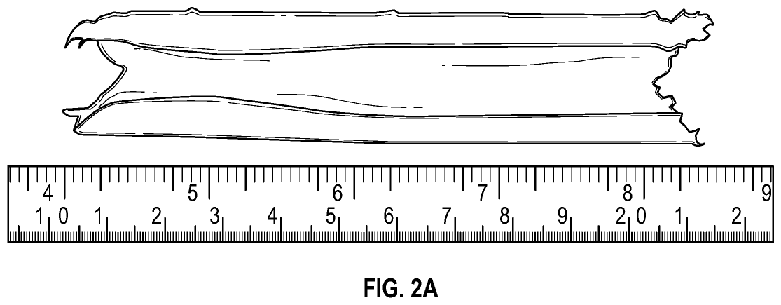

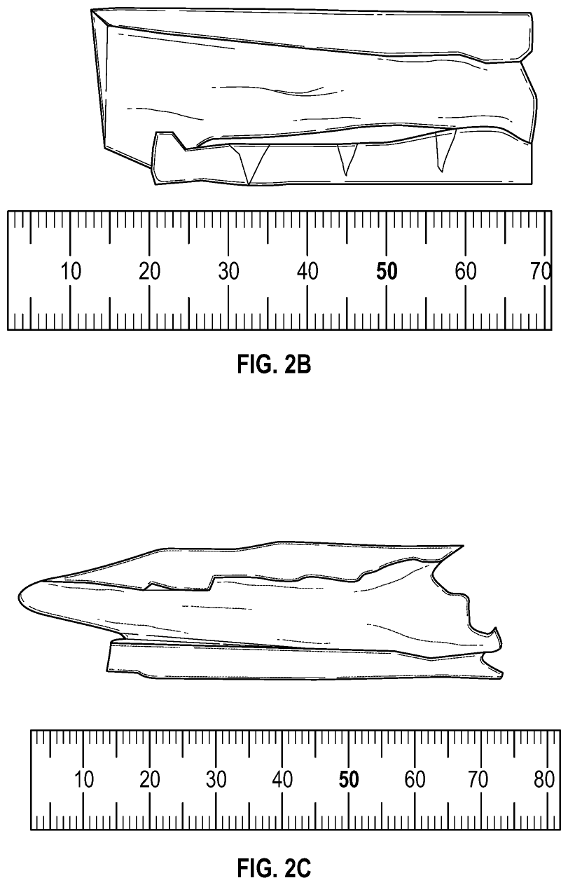

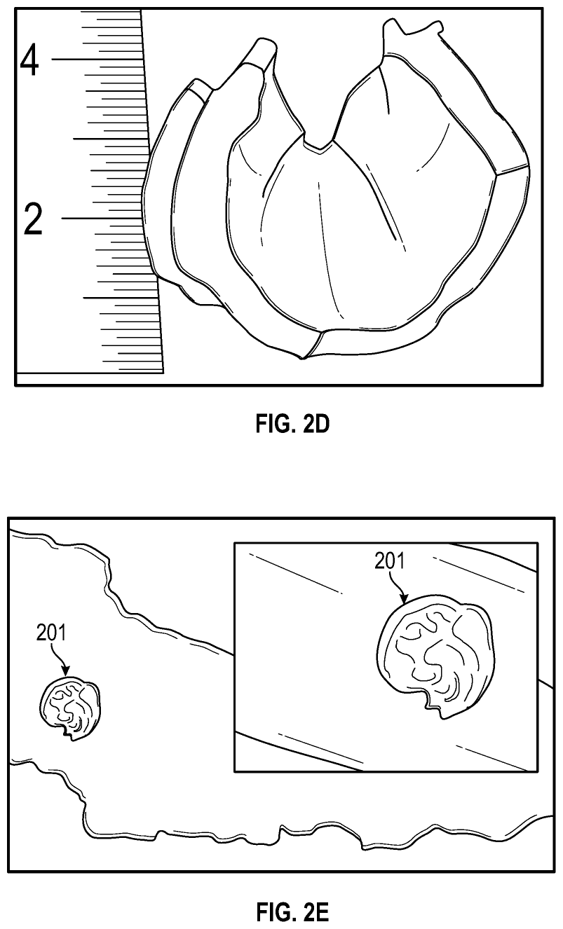

Deposition and growth occurred directly onto the 1-inch diameter quartz tube walls taking on the shape of the tube. The result produced quantities between 2 to 3 grams of CBxNT material in just 30 minutes of growth (60-100 mg/min.), in the form of macroscopic elastic porous solids with unique isotropic structure (see FIGS. 1A-1F and FIGS. 2A-2E), exhibiting unique physico-chemical properties including oleophilicity.

not wishing to be bound to a particular theory, as boron can act as a surfactant during growth [Blase 1999], it is believed this could be a reason for the high yield. The macroscale 3D CBxNT material could be bent to a dramatic degree without breaking, and returned to its original position after released. FIGS. 1A-1B. The CBxNT material had a robust mechanical durability and flexibility in response to ‘flicking’ the material by hand in a cantilever loading fashion. Remarkably, the bulk densities of the porous solids were measured to be in the range of 10 to 29 mg/cm³ (as compared to low density carbon aerogel of 60 mg/cm³). Densities below 10 mg/cm³ may also be achieved by changing the solution feed rate and synthesis temperature accordingly. The nanotube diameters in the CBxNT material ranged from 40 to 150 nm, as measured from electron microscopy images. FIGS. 1C-1F. Diameters may be below 40 nm or even below 20 nm by changing the synthesis parameters such as precursor feed rate, catalyst concentration, temperature, and carrier gas flow rate. The synthesized 3D architecture of the CBxNT material was entirely made up of randomly orientated and entangled CNTs with little to no amorphous carbon as depicted from SEM. Sec FIG. 1C.

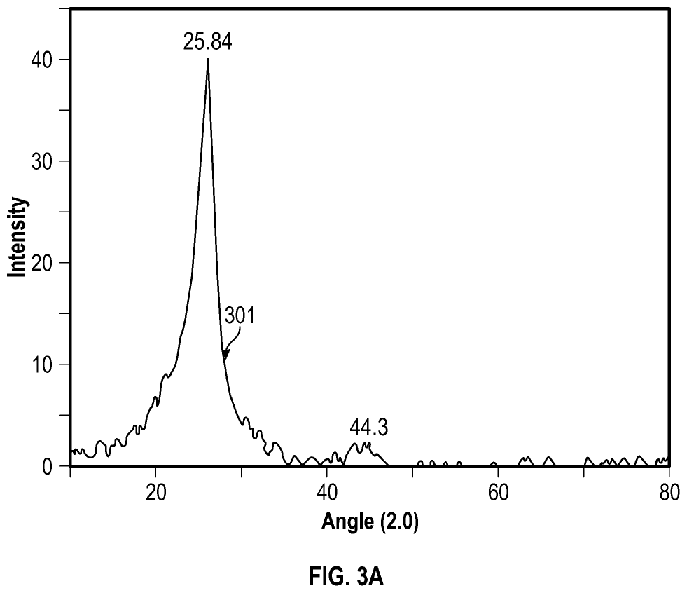

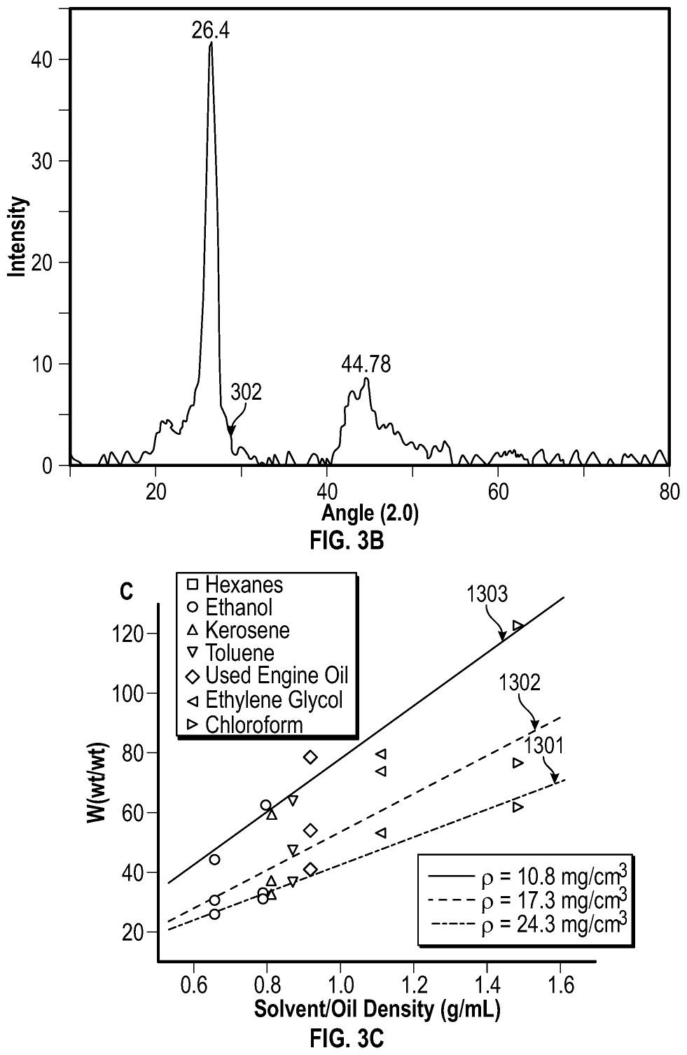

As shown in FIGS. 3A-3B, the x-ray diffraction pattern showed that the as-produced CBxNT materials were crystalline and had sharp (002) diffraction peaks.

The x-ray diffraction pattern of CBxNT material (curve 301) as compared to the x-ray diffraction pattern of pristine (undoped) carbon nanotubes (curve 302) showed evidence of peak broadening and a shift to lower diffraction angle of the (002) planes appeared for CBxNT material. This indicated an increase in the interplane d-spacing (Δd approximately equal to 0.007 nm) between the graphitic carbon nanotubes walls due to the boron substitutionally doped with carbon creating disorder in the lattice.

At longer growth times and the lower solution feed rates, sponge-like materials had lower density, more robust mechanical properties (toughness), higher porosity, and higher specific surface area, while maintaining very high electrical conductivity.

The catalytic role of boron (or other heteroatoms) to prevent tube closure [Blase 1999] was responsible to promoting extraordinarily high yield and efficient growth kinetics for doped carbon nanotube production. It was found that the TEB content in the precursor had a direct relationship with the growth temperature needed for yielding the solid structure. The successful growth conditions for the materials described herein were very sensitive to the TEB concentration. During growth optimization, it was noticed that the presence of TEB resulted in an increase in the reaction temperature. This observation may be explained by the heteroatoms (such as boron atoms) starting to strongly react with the iron catalyst particles to a degree that may alter the carbon diffusion, saturation, and precipitation growth kinetics of long “elbow-defected” heteroatom-doped carbon nanotubes. For the CBxNT material, it was found that the Fe to B ratio ranges from 2 to 6 within the temperature range 900 to 850° C. respectively. Therefore, the possible role of the catalytic effects of atomic boron on the iron catalyst particles during CBxNT can be used to control nanotube 3D architectures. Using boron as a dopant in carbon nanotube synthesis is a strategy for producing “elbows,” which contribute to the elasticity of these networks. The structural integrity of the 3D heteroatom-doped carbon nanotube material is maintained due to the heteroatom induced defects—promoting tube-tube bonding, entanglement, and nanoscale covalent multi-junctions. See FIGS. 1B-1E. In this respect, the doping route seems to be more advantageous, over non-doped CNT entangled networks, holding more promise as a strategy for true (covalent) 3D solid networks with CNTs.

Post-Synthesis Welding Process

Optionally, the synthesized heteroatom-doped carbon nanotube material can be welded after the synthesis process. Accordingly, the invention can further entail a post-synthesis procedure to weld the heteroatom-doped carbon nanotube macroscale 3D material, such as by using microwave radiation energy or ultrasonication, to enhance material properties (mechanical, electrical, chemical reactivity).

The post-processing welding procedure enhances the degree of covalent junctions between individual carbon nanotubes. This, in effect can enhance the overall material properties of the macroscale 3D MWCNT structure.

In the synthesis process, no substrate is needed to provide a 3D distribution of nanotubes in space, such as described in the Chen '258 Patent. The present invention provides a mass-production method of forming the ideal framework of freestanding, randomly orientated, entangled MWCNTs distributed in 3D macro-scale space. Simply drop casting a solution of carbon nanotubes (such as MWCNTs) onto a substrate (in a “pick-up-sticks” fashion) will yield a loose 2D distribution of MWCNTs, in which case, bundling up of CNTs due to van der Waal forces is very difficult to avoid. In the present invention, bundling of the MWCNTs is avoided due to the “elbow” defects and tube morphologies (bends, kinks, Y-, T-, and X-type junctions) induced by the heteroatom doping (boron. sulfur, etc.) which helps to promote the entanglement and to prevent the strong domination of van der Waal forces commonly known with conventional SWCNT and MWCNT randomly orientated powders and anisotropic aligned arrays. The macroscale 3D entangled network of MWCNTs that compose the heteroatom-doped carbon nanotube materials described herein, are therefore in more ideal 3D fixed positions for contacting MWCNTs to weld together within the solid to form macroscale 3D carbon nanotubes. This will result in a virtually monolithic network of carbon nanotubes (such as MWCNTs), which will enhance the overall material properties and performance (in particular the mechanical and electrical properties) of these carbon nanotube elastic solids.

This present invention entails a welding post-processing procedure to provide large-scale synthesis of interconnected carbon nanotube 3D networks in the form of macroscopic porous solids (i.e., macro-scale 3D materials) having further enhanced material properties and performance. Accordingly, the present invention entails the post-synthesis method performed on the aforementioned CVD synthesized structure for preparing interconnected MWCNT networks in three-dimensional (3D) space to form macro-scaled, porous, elastic solids with enhanced material properties.

This can be done by microwave irradiation welding technique to promote crosslinking and create a virtually monolithic covalently bonded network of interconnected carbon nanotubes and/or heteroatom-doped carbon nanotubes (boron, sulfur, nitrogen, or phosphorous). This can be done using the microwave energy parameters similar to those outlined in the Harutyunyan '884 Patent and the Tour '199 Patent as described for application strictly on pristine (non heteroatom-doped) SWCNT and MWCNT loose powders. These methods were for small-scale 2D layering of CNTs (2D stacking or packing of CNTs), which are vulnerable to the strong van der Waal forces rendering the process counterproductive and less efficient to building true 3D porous solid network structures at the macro-scale. These similar parameters may be applied on the present invention; however, in this case, the invention regards the application to 3D heteroatom-doped carbon nanotube materials.

The microwave radiation energy can come from a conventional microwave oven, such as those used as a household appliance; in which case the microwave frequency would be 2.45 GHz and powers that range from 600 to 1400 watts. It is also possible to use other non-conventional microwave frequencies between 1 to 300 GHz, and generally between 1 and 5 GHz.

The power output of the microwave radiation may also vary between 400 watts and 1400 watts. Typically, conventional microwave radiation frequency 2.45 GHz and power output between 600 and 1400 watts is used.

By this “welding process,” temperatures between 1000 and 2000° C. can be reached. Preferably temperatures above 1500° C. may be needed for the breakdown of the carbon-carbon bonds and the reconstruction (welding) of sp² crystalline covalent junctions (crosslinking) between individual carbon nanotubes (such as MWCNTs).

Generally, the process is performed under inert atmosphere conditions, such as nitrogen or argon, to prevent significant oxidation or burning of the carbon nanotubes (such as MWCNTs) at elevated temperatures. Also, the material can be put under vacuum environment conditions such as those below <1 torr, and, more typically, between 10⁻³ to 10⁻⁷ torr (or within an ultra-high vacuum (UHV) chamber). The samples may be sealed within a quartz vessel under such pressure conditions as well.

In some embodiments, the heteroatom-doped carbon nanotubes are chemically functionalized with functional groups before the microwave irradiated procedure.

Moreover, composites can be constructed by such means. For example, in some embodiments, heteroatom-doped carbon nanotubes (functionalized or unfunctionalized) are used in combination with one or more of:

a) carbon nanotubes doped with the same heteroatom, but functionalized with a different substituent,

b) carbon nanotubes doped with other heteroatoms (un-functionalized or functionalized with the same or different substituent),

c) un-doped carbon nanotubes (un-functionalized or functionalized with the same or different substituent), or

d) enhanced heteroatom (such as boron, sulfur etc.) atomic percentage/concentration within the CNT framework by infiltrating additional dopant sources to react and increase/modify the heteroatom-doped carbon nanotubes etc.

The welding process covalently bonds the carbon nanotubes in the heteroatom-doped carbon nanotubes.

Characterizing the Heteroatom Doped Carbon Nanotube Material

It was noticed that the higher density samples resulted in higher stress levels as expected, and the samples were mechanically isotropic due to its random entangled 3D network, similar to the findings of “CNT sponges” recently reported. [Gui I 2010; Gui II 2010]. Control of the density and overall stiffness (resilience) of the sponges can be carried out by changing the solution feed rate. It has been found that a lower feed rate yielded lower densities and more resilient and more flexible sponge-like material.

Strong oleophilic behavior was observed with very high absorption capacity. Weight-to-weight absorption capacity (defined by W (g g⁻¹), the ratio of the final weight after absorption and the initial weight before absorption) for common solvents was measured on CBxNT sponges with three different densities: 24.3 mg/cm³, 17.3 mg/cm³, and 10.8 mg/cm³, and plotted as Lines 1301-1303, respectfully in FIG. 3C. The absorption capacity values, W (g g-1), were obtained by measuring the mass of the dry as-produced sponge, and then measuring the mass after oil/solvent absorption. The ratio of the final mass to the initial mass was taken as the W (g g-1) value, averaging out three samples. To ensure full saturation was obtained before weighing, the samples were left submerged in the solvent/oil (without water) overnight. The samples were then removed with sharp needle tweezers and immediately placed onto a weigh paper to be measured on the mass balance.

Table I reflects the solvent weight-to-weight absorption data for the CBxNT sponges for each of the three different densities of 24.3 mg/cm³, 17.3 mg/cm³, and 10.8 mg/cm³.

TABLE I

| | Sponge | Sponge | Sponge |
|---|---|---|---|
| Solvent | 24.3 mg/cc | 17.3 mg/cc | 10.8 mg/cc |
| Hexanes (0.6548 g/ml) | 26.00 | 29.61 | 44.37 |
| Ethanol (0.789 g/ml) | 30.65 | 33.14 | 62.61 |
| Kerosene (0.81 g/ml) | 31.99 | 36.81 | 59.29 |
| Toluene (0.867 g/ml) | 37.38 | 48.46 | 65.48 |
| Used Engine Oil (0.913 g/ml) | 41.06 | 54.45 | 78.85 |
| Ethylene Glycol (1.1132 g/ml) | 52.98 | 74.38 | 79.526 |
| Chloroform (1.483 g/ml) | 62.28 | 76.91 | 122.86 |

As shown in Table 1, increasing solvent density and decreasing CBxNT sponge density resulted in higher absorption capacity. W increased with lower density sponges and with higher density solvents with as high as W=123 for chloroform (1.483 g/cm³) and as low as W=22 for hexanes (0.655 g/cm³).

The volume-to-volume absorption capacity (defined by V, the volume of the solvent absorbed by the CBxNT sponge per unit volume of the CBxNT sponge before absorption) was calculated from this same data. Table II reflects the volume of solvent absorbed per unit volume of the CBxNT sponges for each of the three different densities of 24.3 mg/cm³, 17.3 mg/cm³, and 10.8 mg/cm³.

TABLE II

| | Sponge | Sponge | Sponge |
|---|---|---|---|
| Solvent | 24.3 mg/cc | 17.3 mg/cc | 10.8 mg/cc |
| Hexanes (0.6548 g/ml) | 92.78% | 75.59% | 71.53% |
| Ethanol (0.789 g/ml) | 91.32% | 70.47% | 84.33% |
| Kerosene (0.81 g/ml) | 92.97% | 76.48% | 77.72% |
| Toluene (0.867 g/ml) | 101.96% | 94.70% | 80.32% |
| Used Engine Oil (0.913 g/ml) | 106.62% | 101.28% | 92.09% |
| Ethylene Glycol (1.1132 g/ml) | 113.47% | 114.04% | 76.18% |
| Chloroform (1.483 g/ml) | 100.41% | 88.55% | 88.74% |

As shown in Table II, the volume of solvent the CBxNT sponges absorbed was between about 70% and about 115% of the volume of the CBxNT sponge before absorption. In use to prepare the composite materials described herein, an organic phase change material can be used in place of the solvents shown above. Other types of phase change materials can also be used, but the highly oleophilic nature of the CBxNT sponges makes them ideally suited for use with organic PCMs.

As noted above, experimental parameters can be varied (tailored) to create a structure of desired properties such as density, porosity, surface area, carbon nanotube diameter, boron doping concentration, etc., and boron content. Experimental parameters might change to some extent for optimizing and controlling growth on a new system. Changing synthesis parameters such as dopant concentration and temperature, give the ability to control the boron defect concentration, density of junctions, and the overall properties of the CBxNT materials. Furthermore, these defects could act as anchor points for chemical or cluster functionalization in order to better tailor CBxNT for various alternative applications.

Varying the synthesis growth time will enhance the structural and mechanical integrity of the entangled network as longer carbon nanotubes will make the CBxNT materials less brittle and less likely to crumble. The metal catalyst (iron, nickel, cobalt, etc.) can also be changed. Carrier gas composition, gas flow rates, solution feed rates, density, porosity, boron concentrations (elbow, defect concentrations), nanotube diameters, number of nanotube walls may also be varied. Composite material variations can be realized. This includes chemical functionalizing, which will affect the properties of the CBxNT materials and physadsorbing metal nanoparticles to the surface of the CBxNT for tailoring selective adsorption of chemical species etc.

Polymer Composites of the Heteroatom Doped Carbon Nanotube Material

In some embodiments, the heteroatom-doped carbon nanotube materials (such as CBxNT materials) can used to form a composite with a polymer binder. For instance, the CBxNTs (or other heteroatom-doped carbon nanotubes) can be functionalized, and a polymer can be bound (by polymerization or otherwise) to the CBxNTs, such as, for example, by using processes similar to those disclosed and taught in Tour '940 Patent, Tour '137 Patent, and Tour '103. Further, for instance, a polymer can be directly bound to the CBxNT, such as, for example, using a process similar to those disclosed and taught in Tour '199 Patent. Also, for instance, a polymer matrix can be used to bind the CBxNT material, such as, for example, using a process similar to those disclosed and taught in Smalley '596 Patent.

Use of the Heteroatom-Doped Carbon Nanotube Material in Processes

By the present invention, it has been discovered that doping of carbon nanotubes with heteroatoms (such as elemental boron) created an entirely different tubule morphology, “elbow” geometrical defect, in the carbon nanotube lattice giving it unique material properties including: chemical, physical, mechanical, and electrical (altered thermal and optical properties are yet to be discovered). The synthesis parameters stated above produced high yields of a 3-dimensional, low density, porous solid sponge-like material composed of a heavily entangled network entirely of clean (little to no amorphous carbon) CBxNTs, which are generally boron-doped multiwall carbon nanotubes (CBxNT's). This nanostructure of the CBxNT material remained self-intact upon many deformation cycles without the need of any polymer binding material(s) to form a composite.

This synthesis procedure of the present invention takes advantage of the fact that boron acts as a “surface-active agent” during growth of carbon nanotubes producing higher yields than its pristine carbon nanotube counterparts (and even higher than nitrogen doping for that matter, which actually has been proven to slow down growth rate). Therefore, novel and unique aspects of this synthetic method include:

This synthesis procedure has shown to be feasible at the large-scale industrial level; considering the low cost of production and the fact that the yields are so high (about 66-100 mg/min).

Based on the oil absorption property, it can be preferred to use hydrocarbon-based phase change materials.

Synthetic examples for producing the sponges described herein are disclosed, for example, in U.S. Publication No. 20120238021 by Daniel Paul Hashim.

### II. Phase Change Materials

Latent heat storage can be achieved through liquid→solid, solid→liquid, solid→gas and liquid→gas phase changes. However, for all practical purposes, solid→liquid and liquid→solid phase changes are primarily used commercially. Liquid→gas transitions require large volumes or high pressures to store the materials in their gas phase, and solid→solid phase changes are typically very slow and have a relatively low heat of transformation.

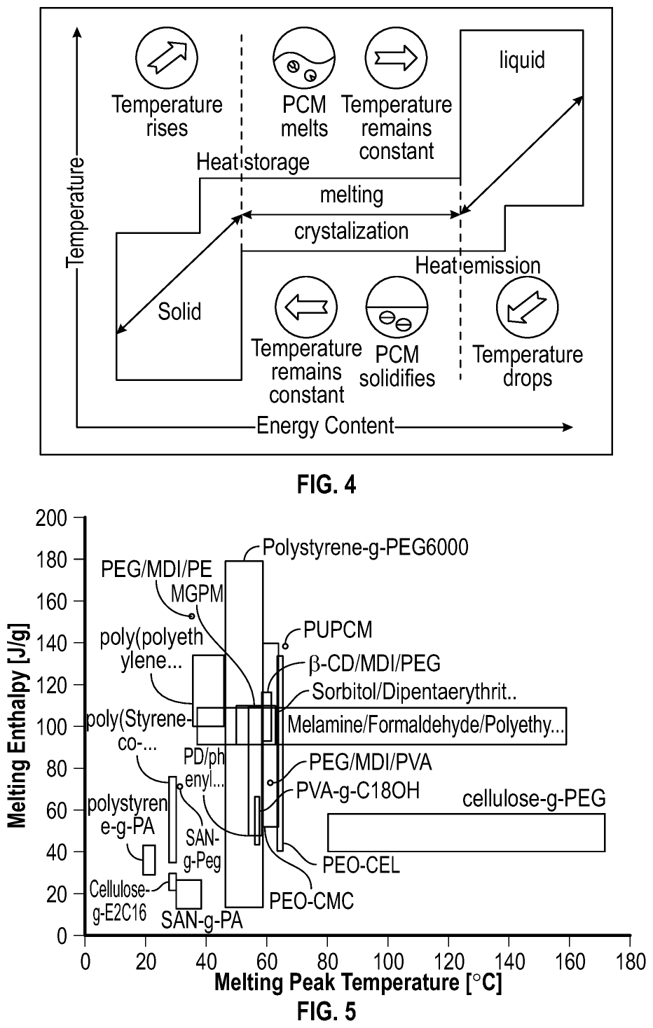

Initially, solid→liquid PCMs behave like sensible heat storage (SHS) materials; their temperature rises as they absorb heat (refer to FIG. 4). FIG. 4 shows the variation of temperature with energy provided to a PCM. Notice the region where the temperature is held constant during the latent heat transition where the PCM undergoes the solid-liquid phase change whereas in the other regions you see the PCM act as a sensible heat storage material (Mishra et al., “Latent Heat Storage Through Phase Change Materials,” Resonance, p. 532-541, June 2015).

The PCM continues to absorb heat without a significant rise in temperature until all the material is transformed to the liquid phase. When the ambient temperature around a liquid material falls, the PCM solidifies, releasing its stored latent heat.

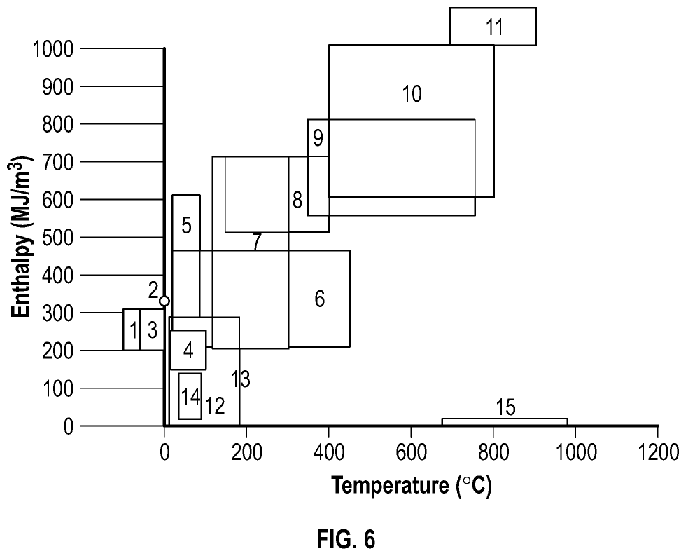

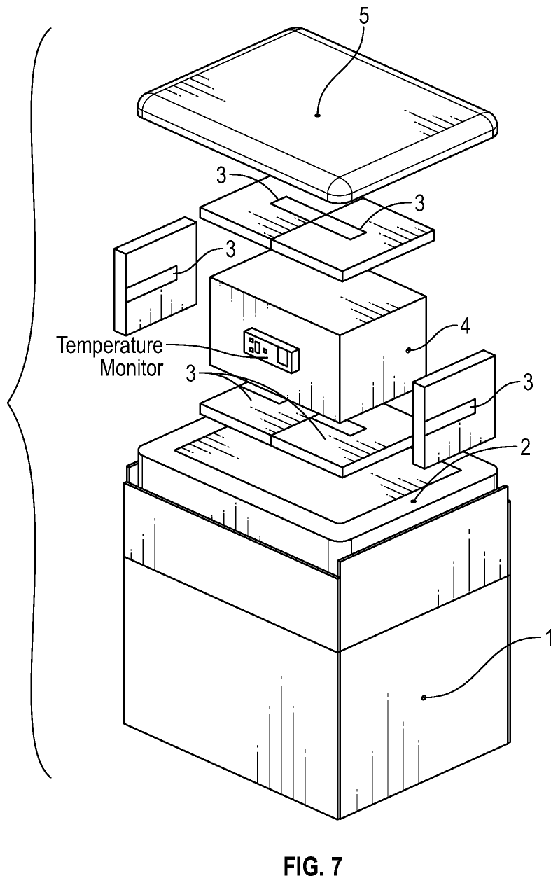

FIG. 5 shows the melting enthalpy and melting temperature ranges for various polymeric SS-PCMs. FIG. 6 shows the enthalpy and temperature ranges for SL-PCMs and SS-PCMs; L-PCMs: (1) Water-salt solutions; (2) Water; (3) Clathrates; (4) Paraffins; (5) Salt hydrates; (6) Sugar alcohols; (7) Nitrates; (8) Hydroxides; (9) Chlorides; (10) Carbonates; (11) Fluorides; (12) Polymeric; SS-PCMS: (12) Polymeric; (13) Organics (Polyols); (14) Organometallics; (15) Inorganics (Metallics). Unlike conventional SHS materials, however, when PCMs reach the temperature at which they change phase (their melting temperature) they absorb large amounts of heat at an almost constant temperature.

There are a large number of commercially available PCMs in most desired temperature ranges, for example, from about −5 up to about 190° C., as well as many PCMs which undergo a phase change at temperatures falling outside of these ranges. Within the human comfort range between 20−30° C., some PCMs are very effective, storing between about 5 to about 14 times more heat per unit volume than conventional storage materials such as water, masonry or rock.

There are many types of PCMs, including organic PCMs, inorganic PCMs, including inorganic salt hydrates, eutectic salt hydrates, hygroscopic materials, and solid-solid phase change materials.

Organic PCMs include bio-based, paraffin-based, lipid-derived, polyol, and carbohydrate PCMs. Some advantages to using organic PCMs include the fact that they tend to freeze without much undercooling, can melt congruently, have self-nucleating properties, are compatible with many conventional construction materials, do not segregate, are chemically stable, have a high heat of fusion, tend to be relatively safe and non-reactive, and tend to be recyclable. There are also several renewable organic PCMs, including carbohydrate and lipid-based PCMs. Some disadvantages include their relatively low thermal conductivity in their solid state, the fact that they require relatively high heat transfer rates during the freezing cycle, their volumetric latent heat storage capacity can be relatively low, compared to other PCMs, and they can be flammable. The flammability risk can be partially alleviated by appropriate containment and/or by incorporating fire retardants.

Inorganic salt hydrates are another type of PCM. They offer certain advantages, including a relatively high volumetric latent heat storage capacity, ready commercial availability and relatively low cost, sharp melting point, high thermal conductivity, high heat of fusion, and non-flammability. They have certain disadvantages as well, including incongruous melting and phase separation upon cycling, which can cause a significant loss in latent heat enthalpy, they can be corrosive to many other materials, such as metals, and their volume change during phase transition is typically relatively high. Super cooling can be a problem in solid-liquid transitions, and nucleating agents are often needed, and they often become inoperative after repeated cycling

Eutectic salt hydrate PCMs are another type of PCM. They are often provided with nucleation and gelling agents for long-term thermal stability, and are encapsulated, in thermoplastic materials or foil, to enhance their physical durability. They are often used in passive temperature stabilization applications, for example, in building HVAC energy conservation.

Inorganic eutectics are another type of PCM, and include combinations of two or more inorganic compounds, or a combination of an organic and an inorganic compound. They offer certain advantages, in that some inorganic eutectics have a relatively sharp melting point, similar to that of a pure substance, and their volumetric storage density tends to be slightly above organic compounds. They also have certain disadvantages, which are largely the same disadvantages as those mentioned above in connection with inorganic PCMs, including reduced thermal performance upon cycling, corrosivity, high volume change, and high supercooling. Sharp crystals may form when the salt hydrate PCM solidifies, potentially causing leaks in cases of macro-encapsulation.

Solid-solid PCM materials are a specialized class of PCMs that undergo a solid/solid phase transition, with the associated absorption and release of large amounts of heat. These materials change their crystalline structure from one lattice configuration to another at a fixed and well-defined temperature, and the transformation can involve latent heats comparable to the most effective solid/liquid PCMs. Such materials are useful because, unlike solid/liquid PCMs, they do not require nucleation to prevent supercooling. Additionally, because it is a solid/solid phase change, there is no visible change in the appearance of the PCM, and there are no problems associated with handling liquids, e.g. containment, potential leakage, etc. Currently the temperature range of solid-solid PCM solutions spans from −50° C. (−58° F.) up to +175° C. (347° F.).

There are various criteria for selecting an appropriate PCM, specifically including their thermodynamic properties. The phase change material should possess as many of these properties as practicable:

Melting temperature in the desired operating temperature range

High latent heat of fusion per unit volume

High specific heat, high density and high thermal conductivity

Small volume changes on phase transformation and small vapor pressure at operating temperatures to reduce the containment problem

Congruent melting

Kinetic properties

High nucleation rate to avoid supercooling of the liquid phase

High rate of crystal growth, so that the system can meet demands of heat recovery from the storage system

Suitable chemical properties, including chemical stability

Completely reversible freeze/melt cycle

No degradation, even after a large number of freeze/melt cycles

The materials should be non-corrosive, non-toxic, non-flammable, and non-explosive.

In addition, the PCMs should have a relatively low cost, and high commercial availability.

The following table shows various commercially used PCMs and their properties.

| | Melting | Heat of | Specific Heat | Conductivity | |
|---|---|---|---|---|---|
| | Point | Fusion | Cp (solid) | K | |
| Material | (° C.) | (KJ · kg⁻¹) | (KJ · kg⁻¹ · K⁻¹) | (W · m⁻¹ · K⁻¹) | Application |
| Water | 0 | 333.6 | 2.05 | 1.6-2.2 | — |
| CaCl₂•6H₂O) | 26-29 | 190.8 | 1.088 | — | Greenhouse |
| Acetamide | 82 | 263 | 1.94 | 0.5 | Solar cooker |
| N-octadecane | 27 | 243.5 | 1.934 | 0.148-0.358 | Building |
| Sodium acetate | 56.7 | 199 | 3.18 | 0.41-0.65 | Thermotherpy |
| trihydrate | | | | | |
| N-eicosane | 36.5 | 247 | 2.46 | 0.1505 | Cooling mobile |
| | | | | | phones, Tex |
| | | | | | tiles, Building |
| Stearic myristic acid | 61-65 | 190.9 | — | — | Solar water |
| (80%-20%) | | | | | heating system |
| Climsel C28 | 28 | 126 | — | 0.5-0.7 | Cooling helmet |
| (Salt Hydrate) | | | | | |
| 0.9 CH₃CONH₂ + | 27.7 | 141 | 2.51 | — | Agricultural |
| 0.1 Ca(NO₃)2•4 H₂O) | | | | | greenhouse |

### Mishra et al., “Latent Heat Storage Through Phase Change Materials,” Resonance, 532-541 (2015).

Additional organic PCM materials, and their properties, are shown below.

| | Melting | | | |
|---|---|---|---|---|
| | temperature | Enthalpy | Thermal conductivity | Density |
| Materials | (° C.) | (kj/kg) | (W/(m K)) | (kg/m³) |
| [symbol] mic acid | 16 | 148.5 | 0.149 (liquid, 38.6° C.) | 901 (liquid, 30° C.) |
| | | | | 981 (solid, 13° C.) |
| Glyceric acid | 64 | 185.4 | 0.162 (liquid, 68.4° C.) | 850 (liquid, 65° C.) |
| | | | | 989 (solid, 24° C.) |
| Polyethylene | 22 | 127.2 | 0.189 (liquid, 38.6° C.) | 1129 (liquid, 25° C.) |
| glycol E600 | | | | 1232 (solid, 4° C.) |
| Paraffins | 64 | 171.6 | 0.167 (liquid 63.5° C.) | 790 (liquid, 65° C.) |
| | | | 0.346 (solid, 33.6° C.) | 916 (solid, 24° C.) |

[symbol]

indicates data missing or illegible when filed

[Source: Zheng et al., Advances in Mechanical Engineering, 2017, Vol. 9(6) 1-20]

Additional inorganic PCMs, and their thermal physical properties, are shown in the table below:

| | Melting | | | |
|---|---|---|---|---|
| | temperature | Enthalpy | Thermal conductivity | Density |
| Materials | (° C.) | (kj/kg) | (W/(m K)) | (kg/m³) |
| 6 | 36 | 146.9 | 0.464 (liquid, 39.9° C.) | 1828 (liquid, 36° C.) |
| | | | 0.469 (liquid, 61.2° C.) | 1937 (solid, 24° C.) |
| 6 | 29 | 190.8 | 0.540 (liquid, 38.7° C.) | 1562 (liquid, 32° C.) |
| | | | 1.088 (solid, 23° C.) | 1802 (solid, 23° C.) |
| | 48 | 265.7 | 0.653 (liquid, 85.7° C.) | 1937 (liquid, 84° C.) |
| | | | 1.225 (solid, 23° C.) | 2070 (solid, 23° C.) |
| 6 | 89 | 162.8 | 0.490 (liquid, 95° C.) | 1550 (liquid, 95° C.) |
| | | | 0.611 (solid, 37° C.) | 1636 (solid, 37° C.) |
| 6 | 117 | 168.6 | 0.570 (liquid, 120° C.) | 1450 (liquid, 120° C.) |
| | | | 0.694 (solid, 90° C.) | 1569 (solid, 90° C.) |

[Source: Zheng et al., Advances in Mechanical Engineering, 2017, Vol. 9(6) 1-20]

The following table compares various methods to store heat, namely using rocks, water, inorganic PCMs, and organic PCMs, and the various properties associated with each approach.

| | | | Inorganic | Organic |
|---|---|---|---|---|
| Property | Rock | Water | PCM | PCM |
| Density, kg/m³ | 2240 | 1000 | 1600 | 800 |
| Specific heat, kj/kg | 1.0 | 4.2 | 2.0 | 2.0 |
| Latent heat, kj/kg | — | — | 230 | 230 |
| Latent heat, kj/m³ | — | — | 368 | 368 |
| Storage mass for j, kg | 6700 | 16.000 | 4350 | 4350 |
| Storage volume for j, m³ | 30 | 16 | 2.7 | 2.7 |
| Relative storage mass | 15 | 4 | 1.0 | 1.0 |
| Relative storage volume | 11 | 6 | 1.0 | 1.0 |

PCM: phase change material

[Source: Zheng et al., Advances in Mechanical Engineering, 2017, Vol. 9(6) 1-20]

The following table shows various physical properties, and thermal conductivity, of fatty acid PCM materials:

| | | | | | Thermal |
|---|---|---|---|---|---|
| | Density | | Specific heat | | conductivity |
| | (kg/m³) | | (kj/(kg K)) | | Liquid |
| Materials | Solid | Liquid | Solid | Liquid | (W/(m K)) |
| Capric acid (CA) | 1004 | 878 | 1.9 | 2.1 | 0.153 |
| Lauric acid (LA) | 1007 | 862 | 1.7 | 2.4 | 0.150 |
| Myristic acid (MA) | 990 | 861 | 1.7 | 2.4 | 0.150 |
| Palmitic acid (PA) | 989 | 850 | 1.9 | 2.8 | 0.162 |
| Stearic acid (SA) | 965 | 849 | 1.6 | 2.2 | 0.172 |

Representative phase change materials are listed below.

Organic Phase Change Materials

| Material | Melting Point T_{M} | Heat of Fusion (kj/kg) |
|---|---|---|
| Paraffin 14-Carbons | 5.5° C. (41.9° F.) | 228 |
| Paraffin 15-Carbons | 10° C. (50° F.) | 205 |
| Paraffin 16-Carbons | 16.7° C. (62.1° F.) | 237.1 |
| Paraffin 17-Carbons | 21.7° C. (71.1° F.) | 213 |
| Paraffin 18-Carbons | 28° C. (82° F.) | 244 |
| Paraffin 19-Carbons | 32° C. (90° F.) | 222 |
| Paraffin 20-Carbons | 36.7° C. (98.1° F.) | 246 |
| Paraffin 21-Carbons | 40.2° C. (104.4° F.) | 200 |
| Paraffin 22-Carbons | 44° C. (111° F.) | 249 |
| Paraffin 23-Carbons | 47.5° C. (117.5° F.) | 232 |
| Paraffin 24-Carbons | 50.6° C. (123.1° F.) | 255 |
| Paraffin 25-Carbons | 49.4° C. (120.9° F.) | 238 |
| Paraffin 26-Carbons | 56.3° C. (133.3° F.) | 256 |
| Paraffin 27-Carbons | 58.8° C. (137.8° F.) | 236 |
| Paraffin 28-Carbons | 61.6° C. (142.9° F.) | 253 |
| Paraffin 29-Carbons | 63.4° C. (146.1° F.) | 240 |
| Paraffin 30-Carbons | 65.4° C. (149.7° F.) | 251 |
| Paraffin 31-Carbons | 68° C. (154° F.) | 242 |
| Paraffin 32-Carbons | 69.5° C. (157.1° F.) | 170 |
| Paraffin 33-Carbons | 73.9° C. (165.0° F.) | 268 |
| Paraffin 34-Carbons | 75.9° C. (168.6° F.) | 269 |
| Formic acid | 7.8° C. (46.0° F.) | 247 |
| Caprilic acid | 16.3° C. (61.3° F.) | 149 |
| Glycerin | 17.9° C. (64.2° F.) | 198.7 |
| p-Lattic acid | 26° C. (79° F.) | 184 |
| Methyl palmitate | 29° C. (84° F.) | 205 |
| Camphenilone | 39° C. (102° F.) | 205 |
| Docasyl bromide | 40° C. (104° F.) | 201 |
| Caprylone | 40° C. (104° F.) | 259 |
| Phenol | 41° C. (106° F.) | 120 |
| Heptadecanone | 41° C. (106° F.) | 201 |
| 1-Cyclohexylooctadecane | 41° C. (106° F.) | 218 |
| 4-Heptadacanone | 41° C. (106° F.) | 197 |
| p-Toluidine | 43.3° C. (109.9° F.) | 167 |
| Cyanamide | 44° C. (111° F.) | 209 |
| Methyl eicosanate | 45° C. (113° F.) | 230 |
| 3-Heptadecanone | 48° C. (118° F.) | 218 |
| 2-Heptadecanone | 48° C. (118° F.) | 218 |
| Hydrocinnamic acid | 48° C. (118° F.) | 118 |
| Cetyl acid | 49.3° C. (120.7° F.) | 141 |
| a-Nepthylamine | 59° C. (138° F.) | 93 |
| Camphene | 50° C. (122° F.) | 238 |
| O-Nitroaniline | 50° C. (122° F.) | 93 |
| 9-Heptadecanone | 51° C. (124° F.) | 213 |
| Thymol | 51.5° C. (124.7° F.) | 115 |
| Methyl behenate | 52° C. (126° F.) | 234 |
| Diphenyl amine | 52.9° C. (127.2° F.) | 107 |
| p-Dichlorobenzene | 53.1° C. (127.6° F.) | 121 |
| Oxolate | 54.3° C. (129.7° F.) | 178 |
| Hypophosphoric acid | 55° C. (131° F.) | 213 |
| O-Xylene dichloride | 55° C. (131° F.) | 121 |
| ß-Chloroacetic acid | 56° C. (133° F.) | 147 |
| Chloroacetic acid | 56° C. (133° F.) | 130 |
| Nitro napthalene | 56.7° C. (134.1° F.) | 103 |
| Trimyristin | 33° C. (91° F.) | 201 |
| Heptaundecanoic acid | 60.6° C. (141.1° F.) | 189 |
| alpha-Chloroacetic acid | 61.2° C. (142.2° F.) | 130 |
| Bees wax | 61.8° C. (143.2° F.) | 177 |
| Glyolic acid | 63° C. (145° F.) | 109 |
| p-Bromophenol | 63.5° C. (146.3° F.) | 86 |
| Azobenzene | 67.1° C. (152.8° F.) | 121 |
| Acrylic acid | 68° C. (154° F.) | 115 |
| Dinitrotoluene (2,4) | 70° C. (158° F.) | 111 |
| Phenylacetic acid | 76.7° C. (170.1° F.) | 102 |
| Thiosinamine | 77° C. (171° F.) | 140 |
| Bromcamphor | 77° C. (171° F.) | 174 |
| Durene | 79.3° C. (174.7° F.) | 156 |
| Methyl bromobenzoate | 81° C. (178° F.) | 126 |
| Alpha napthol | 96° C. (205° F.) | 163 |
| Glautaric acid | 97.5° C. (207.5° F.) | 156 |
| p-Xylene dichloride | 100° C. (212° F.) | 138.7 |
| Catechol | 104.3° C. (219.7° F.) | 207 |
| Quinone | 115° C. (239° F.) | 171 |
| Acetanilide | 118.9° C. (246.0° F.) | 222 |
| Succinic anhydride | 119° C. (246° F.) | 204 |
| Benzoic acid | 121.7° C. (251.1° F.) | 142.8 |
| Stibene | 124° C. (255° F.) | 167 |
| Benzamide | 127.2° C. (261.0° F.) | 169.4 |
| Decanedioic acid | 131° C. to 134.5° C. | 130 |
| (Sebacic acid) | (267.8 to 274.1° F.) | |
| Dodecanoic acid | 43.3° C. | 184 |
| (lauric acid) | | |
| Acetic acid | 16.7° C. (62.1° F.) | 184 |
| Polyethylene glycol 600 | 20° C. (68° F.) | 146 |
| Capric acid | 36° C. (97° F.) | 152 |
| Eladic acid | 47° C. (117° F.) | 218 |
| Pentadecanoic acid | 52.5° C. (126.5° F.) | 178 |
| Tristearin | 56° C. (133° F.) | 191 |
| Myristic acid | 58° C. (136° F.) | 199 |
| Palmatic acid | 55° C. (131° F.) | 163 |
| Stearic acid | 69.4° C. (156.9° F.) | 199 |
| Acetamide | 81° C. (178° F.) | 241 |
| Methyl fumarate | 102° C. (216° F.) | 242 |
| Decyl nonanoate | 6.8° C. | 175 |
| Lauryl nonanoate | 15° C. | 187 |
| Cetyl nonanoate | 24.7° C. | 193 |
| Ethyl myristate | 14° C. | 188 |

A company called Phase Change Energy Solutions, Inc. has commercially available phase change materials known as “Functionalized BioPCM,” which are all bulk, macroencapsulated materials. These materials change their phase at temperatures around −50° C. to 175° C. Materials which change their phase at temperatures between around −50° C. to around 16° C. (i.e., just below room temperature to well below room temperature) are listed below.

| Material | Melting Point T_{M} | Heat of Fusion (kj/kg) |
|---|---|---|
| 0100-Q-50 BioPCM | −50° C. (−58° F.) | 200-230 |
| 0100-Q-45 BioPCM | −45° C. (−49° F.) | 200-230 |
| 0100-Q-40 BioPCM | −40° C. (−40° F.) | 200-230 |
| 0100-Q-35 BioPCM | −35° C. (−31° F.) | 200-230 |
| 0100-Q-30 BioPCM | −30° C. (−22° F.) | 200-230 |
| 0100-Q-27 BioPCM | −27° C. (−17° F.) | 200-230 |
| 0100-Q-25 BioPCM | −25° C. (−13° F.) | 200-230 |
| 0100-Q-22 BioPCM | −22° C. (−8° F.) | 200-230 |
| 0100-Q-20 BioPCM | −20° C. (−4° F.) | 200-230 |
| 0100-Q-15 BioPCM | −15° C. (5° F.) | 200-230 |
| 0100-Q-10 BioPCM | −10° C. (14° F.) | 200-230 |
| 0100-Q-05 BioPCM | −5° C. (23° F.) | 200-230 |
| 0200-Q1 BioPCM | 1° C. (34° F.) | 325 |
| 0200-Q2 BioPCM | 2° C. (36° F.) | 200-230 |
| 0200-Q4 BioPCM | 4° C. (39° F.) | 200-230 |
| 0200-Q5 BioPCM | 5° C. (41° F.) | 200-230 |
| 0200-Q6 BioPCM | 6° C. (43° F.) | 200-230 |
| 0200-Q8 BioPCM | 8° C. (46° F.) | 200-230 |
| 0300-Q10 BioPCM | 10° C. (50° F.) | 200-230 |
| 0300-Q12 BioPCM | 12° C. (54° F.) | 200-230 |
| 0300-Q14 BioPCM | 14° C. (57° F.) | 200-230 |
| 0400-Q15 BioPCM | 15° C. (59° F.) | 200-230 |
| 0400-Q16 BioPCM | 16° C. (61° F.) | 200-230 |

Additional phase change materials are available from Insolcorp. These are inorganic, macroencapsulated materials, which undergo a phase change between around 18 and about 29° C.

| Material | Melting Point T_{M} | Heat of Fusion (kj/kg) |
|---|---|---|
| 18 C° Infinite R | 18° C. (64° F.) | 200 |
| 21 C° Infinite R | 21° C. (70° F.) | 200 |
| 23 C° Infinite R | 23° C. (73° F.) | 200 |
| 25 C° Infinite R | 25° C. (77° F.) | 200 |
| 29 C° Infinite R | 29° C. (84° F.) | 200 |

Still further materials are available from Pluss, which melt/freeze at temperatures between around −30 to around 9.5° C.:

| Material | Melting Point T_{M} | Heat of Fusion (kj/kg) |
|---|---|---|
| savE HS 33N | −30° C. (−22° F.) | 224 |
| savE HS 26N | −24° C. (−11° F.) | 222 |
| savE HS 23N | −20° C. (−4° F.) | 210 |
| savE HS 18N | −18° C. (0° F.) | 242 |
| savE HS 15N | −15° C. (5° F.) | 280 |
| savE HS 10N | −10° C. (14° F.) | 230 |
| savE HS 7N | −6° C. (21° F.) | 230 |
| savE HS 01 | 1° C. (34° F.) | 290 |
| savE OM 03 | 3.5° C. (38.3° F.) | 240 |
| savE FS 03 | 3.6° C. (38.5° F.) | 214 |
| savE OM 05 | 5.5° C. (41.9° F.) | 130 |
| savE FS 05 | 5.9° C. (42.6° F.) | 110 |
| savE OM 08 | 9° C. (48° F.) | 220 |
| savE OM 11 | 9.5° C. (49.1° F.) | 240 |

Additional bulk organic phase change materials are available from PureTemp LLC. Materials undergoing a phase change between about −37 to 18° C. are listed below:

| Material | Melting Point T_{M} | Heat of Fusion (kj/kg) |
|---|---|---|
| PureTemp −37 | −37° C. (−35° F.) | 147 |
| PureTemp −23 | −23° C. (−9° F.) | 145 |
| PureTemp −21 | −21° C. (−6° F.) | 240 |
| PureTemp −17 | −17° C. (1° F.) | 145 |
| PureTemp −15 | −15° C. (5° F.) | 286 |
| PureTemp −12 | −12° C. (10° F.) | 168 |
| PureTemp −2 | −5° C. (23° F.) | 150 |
| PureTemp 1 | 1° C. (34° F.) | 300 |
| PureTemp 4 | 4° C. (39° F.) | 187 |
| PureTemp 6 | 6° C. (43° F.) | 170 |
| PureTemp 8 | 8° C. (46° F.) | 180 |
| PureTemp 12 | 12° C. (54° F.) | 185 |
| PureTemp 15 | 15° C. (59° F.) | 165 |
| PureTemp 18 | 18° C. (64° F.) | 189 |

Still further phase change materials, in this case, bulk inorganic materials, are available from Climator. Materials undergoing a phase change between around −21 and about 21° C. are listed below:

| Material | Melting Point T_{M} | Heat of Fusion (kj/kg) |
|---|---|---|
| Climsel C −21 | −21° C. (−6° F.) | 288 |
| Climsel C −18 | −18° C. (0° F.) | 288 |
| Climsel C 7 | 7° C. (45° F.) | 126 |
| Climsel C 10 | 10.5° C. (50.9° F.) | 126 |
| Climsel C 21 | 21° C. (70° F.) | 112 |

Additional bulk, organic phase change materials are available from Rubitherm GmbH. Materials undergoing a phase change between about −9 and about 18 C are listed below:

| Material | Melting Point T_{M} | Heat of Fusion (kj/kg) |
|---|---|---|
| RT −9 HC | −9° C. (16° F.) | 260 |
| RT −4 | −4° C. (25° F.) | 179 |
| RT 0 | 0° C. (32° F.) | 225 |
| RT 2 HC | 2° C. (36° F.) | 205 |
| RT 3 | 3° C. (37° F.) | 198 |
| RT 3 HC | 3° C. (37° F.) | 250 |
| RT 4 | 4° C. (39° F.) | 182 |
| RT 5 | 5° C. (41° F.) | 180 |
| RT 5 HC | 5° C. (41° F.) | 240 |
| RT 6 | 6° C. (43° F.) | 175 |
| RT 8 | 8° C. (46° F.) | 180 |
| RT 9 | 9° C. (48° F.) | 160 |
| RT 10 | 10° C. (50° F.) | 150 |
| RT 10 HC | 10° C. (50° F.) | 195 |
| RT 11 HC | 11° C. (52° F.) | 190 |
| RT 12 | 12° C. (54° F.) | 150 |
| RT 15 | 15° C. (59° F.) | 140 |
| RT 18 HC | 18° C. (64° F.) | 250 |

Additional bulk organic and bulk eutectic phase change materials are available from PlusICE. Those materials undergoing a phase change between about −114° C. and about 17° C. are listed below:

| Material | Melting Point T_{M} | Heat of Fusion (kj/kg) |
|---|---|---|
| A17 | 17° C. (63° F.) | 150 |
| A16 | 16° C. (61° F.) | 213 |
| A15 | 15° C. (59° F.) | 130 |
| A9 | 9° C. (48° F.) | 140 |
| A8 | 8° C. (46° F.) | 150 |
| A6 | 6° C. (43° F.) | 150 |
| A4 | 4° C. (39° F.) | 200 |
| A3 | 3° C. (37° F.) | 200 |
| A2 | 2° C. (36° F.) | 200 |
| E0 | 0° C. (32° F.) | 332 |
| E-2 | −2° C. (28° F.) | 306 |
| E-3 | −3.7° C. (25.3° F.) | 312 |
| E-6 | −6° C. (21° F.) | 275 |
| E-10 | −10° C. (14° F.) | 286 |
| E-11 | −11.6° C. (11.1° F.) | 301 |
| E-12 | −12.3° C. (9.9° F.) | 250 |
| E-14 | −14.8° C. (5.4° F.) | 243 |
| E-15 | −15° C. (5° F.) | 303 |
| E-19 | −18.7° C. (−1.7° F.) | 282 |
| E-21 | −20.6° C. (−5.1° F.) | 263 |
| E-22 | −22° C. (−8° F.) | 234 |
| E-26 | −26° C. (−15° F.) | 260 |
| E-29 | −29° C. (−20° F.) | 222 |
| E-32 | −32° C. (−26° F.) | 243 |
| E-34 | −33.6° C. (−28.5° F.) | 240 |
| E-37 | −36.5° C. (−33.7° F.) | 213 |
| E-50 | −49.8° C. (−57.6° F.) | 218 |
| E-75 | −75° C. (−103° F.) | 102 |
| E-78 | −78° C. (−108° F.) | 115 |
| E-90 | −90° C. (−130° F.) | 90 |
| E-114 | −114° C. (−173° F.) | 107 |

Additional inorganic bulk phase change materials are available from SAVENERG. Those materials which undergo a phase change between about −26 and about 11° C. are listed below:

| Material | Melting Point T_{M} | Heat of Fusion (kj/kg) |
|---|---|---|
| PCM-HS26N | −26° C. (−15° F.) | 205 |
| PCM-HS23N | −23° C. (−9° F.) | 200 |
| PCM-HS10N | −10° C. (14° F.) | 220 |
| PCM-HS07N | −7° C. (19° F.) | 230 |
| PCM-HS01P | 0° C. (32° F.) | 290 |
| PCM-OM05P | 5° C. (41° F.) | 198 |
| PCM-0M06P | 5.5° C. (41.9° F.) | 260 |
| PCM-0M08P | 8° C. (46° F.) | 190 |
| PCM-0M11P | 11° C. (52° F.) | 260 |

Additional organic, microencapsulated materials are available from Microtek. Those materials undergoing a phase change between about −30 and about 18° C. are listed below:

| Material | Melting Point T_{M} | Heat of Fusion (kj/kg) |
|---|---|---|
| MPCM −30 | −30° C. (−22° F.) | 145 |
| MPCM −30D | −30° C. (−22° F.) | 145 |
| MPCM −10 | −9.5° C. (14.9° F.) | 155 |
| MPCM −10D | −9.5° C. (14.9° F.) | 155 |
| MPCM 6 | 6° C. (43° F.) | 162 |
| MPCM 6D | 6° C. (43° F.) | 162 |
| MPCM 18 | 18° C. (64° F.) | 168 |
| MPCM 18D | 18° C. (64° F.) | 168 |

The most commonly used PCMs are salt hydrates, fatty acids and esters, and various paraffins (such as octadecane). Ionic liquids have also been investigated as PCMs. As most of the organic solutions are water-free, they can be exposed to air, but all salt-based PCM solutions must be encapsulated to prevent water evaporation or uptake. Both types offer certain advantages and disadvantages, and if they are correctly applied, some of the disadvantages become an advantage in certain applications.

The temperature range offered by the PCM technology provides a new horizon for the building services and refrigeration engineers regarding medium and high temperature energy storage applications. The scope of this thermal energy application is wide-ranging of solar heating, hot water, heating rejection, i.e. cooling tower and dry cooler circuitry thermal energy storage applications.

Since PCMs typically transform between solid and liquid phases in thermal cycling, they are often encapsulated to avoid having them leak out during storage. The encapsulation can be micro-encapsulation or macro-encapsulation. One potential issue with macro-encapsulation is that containers with a relatively large volume are not preferred, due to the poor thermal conductivity of most PCMs. The PCMs tend to solidify at the edges of the containers, which can prevent effective heat transfer. Micro-encapsulation tends to not share this problem, and allows the PCMs to be incorporated into construction materials, such as concrete, easily and economically. Micro-encapsulated PCMs also provide a portable heat storage system. By coating a microscopic sized PCM with a protective coating, the particles can be suspended within a continuous phase, such as water (known as a phase change slurry (PCS)).

Molecular-encapsulation is another technology. It allows a relatively high concentration of PCM within a polymer compound, can provide a storage capacity up to 515 kJ/m² for a 5 mm board (103 MJ/m³), and allows the material to be drilled or cut without significant PCM leakage.

As phase change materials perform best in small containers, therefore they are usually divided in cells. The cells are typically relatively shallow to reduce static head, based on the principle of shallow container geometry. To be effective, the packaging material must conduct heat well, and should be durable enough to withstand frequent changes in the storage material's volume as phase changes occur. It should also restrict the passage of water through the walls, so the materials will not dry out (or water-out, if the material is hygroscopic). The packaging must also resist leakage and corrosion. Common packaging materials showing chemical compatibility with room temperature PCMs include stainless steel and polyolefins such as polyethylene and polypropylene.

As and where possible, it can be best to avoid encapsulation at all. However, this requires a material that can hold onto the PCM when it is in the liquid state. As discussed above, the highly porous spongy three-dimensional carbon nanotube materials described herein have a relatively high adsorption of organic materials, and are highly porous. This enables them to provide a suitable sealing structure to control the leakage of PCMs while they are in the liquid state.

While the composite materials described herein can be encapsulated, they need not be, offering advantages over micro- and macro-encapsulation technologies.

Thermal Properties of Different Types of Solid-Solid-PCMs

The tables below summarize thermal property information for approximately 66 different SS-PCM systems reported in the literature. The information is organized into four major SS-PCMs material types: polymeric, organic, organometallic, and inorganic SS-PCMs, based on the difference in their molecular structure. A discussion follows on the general trends observed for each material type, and the relationship between molecular structure, processes involved during phase transition, and thermal properties is assessed. These materials may also be formed as a composite with the nanosponge.

The following table shows thermal properties for various polymeric SS-PCMs:

| | Melting | | Crystallization | | |
|---|---|---|---|---|---|
| | peak | Melting | peak | | Heating |
| PCM Type | temperature | enthalpy | temperature | Crystallization | rate |
| Polymeric | [° C.] | [J/g] | [° C.] | entralpy [J/g] | [° C.] |
| 1. Crafted | | | | | |
| SAN-g-PA | 29.2-37.5 | 11.6-23.7 | 31.3-41.5 | 11.7-24.4 | 10 |
| SAN-g-Peg | 30.0 | 66.8 | 49.0 | 68.2 | 10 |
| PVA-g-C18OH | 55.1-56.5 | 41-65 | 45.3-49.4 | 40-63 | 10 |
| polystyrene-g-PA | 18.7-21.5 | 26.2-39.8 | 17.6-18.7 | 20-39.2 | 5 |
| cellulose-g-PEG | 42.8-60.1 | 77.6-203.2 | 25.1-40.6 | 44.7-203.2 | 10 |
| Cellulose-g-E2C18 | 28.2-28.6 | 21-28 | 12.9-14.9 | 18-30 | 10 |
| Poly(Styrene-co-Allyalcohol)-g-SA | 27-29 | 34-74 | 25-30 | 28-71 | 1 |
| Polystyrene-g-PEG [symbol] | 44.9-58.0 | 111.5-179.5 | 34.4-38.5 | 99.4-143.6 | 5 |
| 2. Blocked | | | | | |
| PUPCM | 65.28 | 138.7 | 38.58 | 126.2 | 10 |
| 3. Cross linked | | | | | |
| β-CD/MDI/PEG | 57.6-60.2 | 92.3-115.2 | 43.5-47.8 | 90.3-11.6 | 2 |
| Sorbitol/Dipentaerythritol/Inositol/PEG | 36-59.9 | 91.0-107.5 | 44.0-45.5 | 86.1-102.9 | 2 |
| PEG/MDI/PE | 38 | — | 68 | 153 | 10 |
| Melamine/Formaldehyde/Polyethyl | 49.1-57.7 | 91.1-109.4 | 28.3-36.9 | 85.3-103.9 | 10 |
| Eneglycols (MFPEG) | | | | | |
| PEG/MDI/PVA | 61.1 | 72.8 | 34 | — | 10 |
| 4. Others | | | | | |
| PEO-CEL (Physical Blending) | 62.5-63.4 | 40.6-134.7 | 32.5-39.5 | 40.2-127.3 | 10 |
| PEO-CMC (Physical Blending) | 58.4-62.5 | 52.8-140.2 | 35.3-41.3 | 5.2-138 | 10 |
| MGPM | 55.3 | 108.5 | 18.3 | 81.6 | 10 |
| poly(polyethylene glycol methyl | 35.8-44.7 | 99.7-132.5 | 1.4-14.4 | 94.5-118.6 | 5 |
| ether methacrylates) | | | | | |
| (BULCK POLYMERIZATION) | | | | | |
| PD/Phenyl Ethylene | 53.2-57.7 | 47.2-108.8 | 1.5-18.3 | 33.9-81.6 | 10 |
| (END GROUPS MODIFICATION) | | | | | |

[symbol]

indicates data missing or illegible when filed

Additional information on thermal properties for various organic SS-PCMs is shown in the following table:

| | Melting | | Crystallization | | |
|---|---|---|---|---|---|
| PCM Type | peak | Melting | peak | | Heating |
| Organic | temperature | enthalpy | temperature | Crystallization | rate |
| (polyalcohol) | [° C.] | [J/g] | [° C.] | entralpy [J/g] | [° C.] |
| PE-TAM | | | | | |
| PEAK 1 | 54-158 | 61.8-213.1 | 127.3-188.8 | 121.7-209.8 | 5 |
| PEAK 2 | 184.6 | 142 | 188.6 | 14.3 | 5 |
| AMPD/TAM | | | | | |
| PEAK 1 | 114.7-122.6 | 5.1-181.5 | 19.3-187.1 | 20-203.8 | 5 |
| PEAK 2 | — | — | 79.5 | 71.4 | 5 |
| NPG/TAM/PE | | | | | |
| PEAK 1 | 25.8 | 21.0 | 166.9 | 29.7 | 5 |
| PEAK 2 | 121.1 | 121.5 | 175 | 24.3 | 5 |
| NPG/TAM/PE/AMPD | | | | | |
| PEAK 1 | 34.7 | 62.6 | 117.1 | 44.8 | 5 |
| PEAK 2 | 171.6 | 14.1 | 169.6 | 17.4 | 5 |
| PEAK 3 | 178.1 | 13.1 | — | — | 5 |
| NPG/PE* | | | | | |
| PEAK 1 | 32.0-37.4 | 18.8-68.2 | 25.9-31.3 | 18.8-51.7 | 5 |
| PEAK 2 | 160.3-169.8 | 83.0-147.7 | 109.5-172.3 | 81.4-125.3 | 5 |
| NPG/TAM | | | | | |
| PEAK 1 | 35.6-38.6 | 27.1-143.3 | 22.1-30.3 | 33.0-150.1 | 5 |
| PE/PG | | | | | |
| PEAK 1 | 82-187 | 139.0-270.3 | — | — | — |
| PG/NPG | | | | | |
| PEAK 1 | 24-89 | 66.2-139.0 | | | |
| PE/NPG | | | — | — | — |
| PEAK 1 | 39-187.0 | 49.9-270.3 | — | — | — |
| PE | | | | | |
| PEAK 1 | 189.4 | 339.5 | — | — | — |
| NPG | | | | | |
| PEAK 1 | 42.4 | 119.1 | — | — | — |
| TAM | | | | | |
| PEAK 1 | 132.4 | 295.6 | — | — | — |
| NPG/PE | | | | | |
| PEAK 1 | 32.0-37.4 | 18.6-68.2 | — | — | — |
| PEAK 2 | 160.3-169.8 | 18.8-26.2 | — | — | — |
| NPG/TAM | | | | | |
| PEAK 1 | 35.6-38.6 | 27.1-143-3 | — | — | — |
| PEG | | | | | |
| PEAK 1 | 60.4 | 148.1 | 47.6 | 139.3 | — |
| MDI | | | | | |
| PEAK 1 | 56.7 | 108.7 | 46.1 | 106.7 | — |
| PEG/MDI | | | | | |
| PEAK 1 | 60-61.4 | 120.5-131.9 | 45.5-46.3 | 116.3-121.4 | — |

*OSC heating rate: 5° C./min & cooling rate: 18° C./min (below 30° C.), 0.5° C./min (below 20° C.), and 0.2° C./min (below 10° C.).

[Source: Fallahi, Ali & Guldentops, Gert & Tao, Mingjiang & Granados-Focil, Sergio & Van Dessel, Steven. (2017). Review on solid-solid phase change materials for thermal energy storage: Molecular structure and thermal properties. Applied Thermal Engineering. 127. 1427-1441. 10.1016/j.applthermaleng.2017.08.161]

The following table shows thermal properties for organometallic SS-PCMs.

| PCM formula | T_{z} (° C.) | H_{c} (J/g)^{a} | r₂ (kg/m³) |
|---|---|---|---|
| C₁₀Mn | 32.8 | 70.34 | — |
| C₁₀Cu | 33.8-36.9 | 62.57 | — |
| C₁₂Cu | 52.5-53.8 | 70.15, 147.13^{b} | 1111 |
| C₁₂Mn | 54.1-56.4 | 80.8 | — |
| C₁₂Co | 60.7-88.0 | 92.89 | — |
| C₁₄Cu | 69.2-79.5 | 163.99 | 1186 |
| C₁₅Cu | 72.3-87.8 | 126.42 | 1243 |
| C₁₀Cu | 72.8-96.0 | 79.76 | — |
| C₁₀Mn | 73.1-91.0 | 104.48 | — |
| C₁₀Co | 77.7-82 | 74.28 | — |
| C₁₀Zn | 80.1-162.8 | 100.92 | — |
| C₁₂Zn | 88.2-156.0 | 120.23 | — |
| C₁₀Co | 93.4-164.1 | 153.79 | — |
| C₁₀Zn | 99.1-160.5 | 137.52 | — |

^{a}Temperature range represents minimum and maximum temperature over multiple solid transitions. Ht is the total enthalpy for
^{b}Multiple enthalpy values represent discrepancy in reported heat release data between sources.

[Source: Fallahi, Ali & Guldentops, Gert & Tao, Mingjiang & Granados-Focil, Sergio & Van Dessel, Steven. (2017). Review on solid-solid phase change materials for thermal energy storage: Molecular structure and thermal properties. Applied Thermal Engineering. 127. 1427-1441. 10.1016/j.applthermaleng.2017.08.161]

The following table shows thermal properties for inorganic SS-PCMs.

| | Melting peak | Melting | Crystallization | | |
|---|---|---|---|---|---|
| PCM Type | temperature | enthalpy | peak temperature | Crystallization | Heating rate |
| Iorganic | [° C.] | [J/g] | [° C.] | entralpy [J/g] | [° C.] |
| FE-15CO | 935 | 49 | 925 | 52 | 10 |
| FE-20CO | 950 | 49 | 942 | 50 | 10 |
| FE-30CO | 977 | 51 | 965 | 54 | 10 |
| FE-40CO | 988 | 53 | 979 | 57 | 10 |
| FE-10CO-5CK | 844 | 36 | 803 | 57 | 10 |
| FE-2SI | 683 | 34 | 885 | 32 | 10 |
| FE-106L | 680 | 34 | 882 | 32 | 10 |

### III. Thermal Composites

Thermal-composites is a term given to combinations of phase change materials (PCMs) and the porous three-dimensional carbon nanotube materials described herein. In some ways, the composite materials described herein are analogous to copper-mesh immersed in paraffin-wax. Copper-mesh within paraffin-wax can be considered a composite material, dubbed a thermal-composite. Such hybrid materials are created to achieve specific overall or bulk properties.

Thermal conductivity is a common property which is targeted for maximization by creating thermal composites. The basic idea is to increase thermal conductivity by adding a highly conducting solid (such as the copper-mesh in the copper-mesh in the copper-mesh/paraffin wax example, or the porous three dimensional carbon nanotube materials described herein) into the relatively low conducting PCM, which increases the overall (or bulk) thermal conductivity. If the PCM would normally flow when melted, the three-dimensional carbon nanotube materials described herein are porous, and oleophilic, so can entrain the PCM when melted.

Just like fiberglass or Kevlar are used to provide support for the matrix (the glue which solidifies to hold the fibers and provide compressive strength) in pre-pregs in the aerospace industry, the three-dimensional carbon nanotube materials described herein provide support for the PCMs they encapsulate.

One way to incorporate the PCMs into the spongy three-dimensional carbon nanotube materials described herein is to melt the PCMs, and use vacuum impregnation to impregnate the spongy material with the molten PCM. Then, the PCMs can be cooled to a desired temperature and the resulting composite material used in any desired application where a PCM, such as a micro- or macro-encapsulated PCM would normally be used. If desired, the PCM-impregnated three-dimensional carbon nanotube materials described herein can be encapsulated, including by micro- and/or macro-encapsulation methods. The reinforcement provided by the three-dimensional carbon nanotube materials described herein can provide the resulting composite with superior physical properties than the corresponding unencapsulated PCM, due to the reinforcing nature of the porous three-dimensional carbon nanotube materials.

### IV. Applications

The composite materials described herein can be used in a variety of applications.

In one embodiment, the composite materials are used to control the temperature of medical and life science products during shipping and transportation. Other medical applications including treating birth asphyxia, by maintaining the baby's brain at a relatively low temperature.

In other applications, the composite materials are used in anti-icing applications, for example, to delay ice and frost formation on surfaces in thermal energy storage or in waste heat recovery.

The materials can be used to heat or cool during off-peak power, for example, in heat pump systems, passive storage in bioclimatic building/architecture (HDPE, paraffin), solar cooking, cold-energy batteries, conditioning of buildings, including providing insulation for pipes, and insulation in walls, and cooling and/or heating electrical engines.

In other embodiments, the composite materials are used to provide cooling to food, beverages, coffee, wine, milk products, and even green houses.

In textile and clothing applications, the materials can provide heating or cooling, for example, in harsh environments, or under bulky clothing, costumes, or uniforms.

In connection with chemical reactions, the materials can smooth exothermic temperature peaks.

The materials can also be used in solar power plants to store heat that is generated in boilers, hot water systems, and solar thermal energy systems, particularly when they are looking to exploit off-peak electricity tariffs.

The materials can be used to heat or cool vehicles, including automobiles, aircraft, spacecraft, ships and boats, and to provide thermal protection to electronic devices, such as computers.

In one embodiment, the materials are used to protect telecom shelters in tropical regions. They protect the high-value equipment in the shelter by keeping the indoor air temperature below the maximum permissible by absorbing heat generated by power-hungry equipment such as a Base Station Subsystem. In case of a power failure to conventional cooling systems, PCMs minimize use of diesel generators, and this can translate into enormous savings across thousands of telecom sites in tropics.

Shipping and Storage of Pharmaceuticals, Medical and Life Science Products

The composite materials described herein can be used in a variety of applications related to the shipping and storage of medical and life science products, including pharmaceuticals and biological agents. The composite materials can meet the strict requirements of thermal control needed for shipping and storing these products.

The composite materials can provide precise temperature control during shipping and storage of biological products. They have the capacity to store large amounts of thermal energy as latent heat to provide longer “hold-over” times with precise temperature control and minimal cost of implementation.

As the melting point of the PCMs used in the composite materials is known, the composite materials offer precise temperature control. The high thermal conductivity of the porous foam material, coupled with the thermal capacity of the PCMs, allows large amounts of thermal energy to be absorbed before the materials being shipped or stored undergo any temperature change.

There are different product applications. In one embodiment, products must be shipped and/or stored frozen, and the temperature ranges for the PCMs for this embodiment are typically between about −100 and about 0° C., more typically between about −40 and about −10° C., and still more typically, between about −25 and −18° C. In one aspect of this embodiment, a package containing the composite materials may be cooled to a temperature 1-20 degrees cooler than the phase transition temperature, so that the material can absorb heat as the temperature rises to the phase transition temperature, and then absorb additional heat as it undergoes a phase change. Examples of products that must be shipped frozen include diagnostic specimens, clinical trial specimens, plasma, and vaccines.

In another embodiment, products are meant to be shipped refrigerated, but not frozen, and the temperature ranges for the PCMs for this embodiment are typically between about 0 and 10° C., more typically between around 2 and around 8° C. Examples of such products include pharmaceutical drugs, vaccines, red blood cells, thawed plasma (for storage when not used immediately), diagnostic specimens, and clinical trial specimens. In one aspect of this embodiment, a package containing the composite materials may be cooled to a temperature 1-8 degrees cooler than the phase transition temperature, so that the material can absorb heat as the temperature rises to the phase transition temperature, and then absorb additional heat as it undergoes a phase change.

In still another embodiment, products are shipped at a controlled room temperature range, for example, between about 15 and about 30° C., more typically, between about 15 and about 25° C. Examples include diagnostic specimens, clinical trial specimens, platelets, and cord blood.

Still other products are shipped at their incubation temperature, which is typically in the range of about 34 to about 40° C., more preferably, between about 34 and about 37° C. Representative products include clinical trial specimens, incubated cultures, live mammalian tissue, and thawed plasma, prepared for immediate transfusion.

Blood products are examples of biological products that need to be shipped and stored at various temperatures. Red Blood Cells (RBC) carry oxygen and carbon dioxide to and from tissues and nutrition to body tissues. White Blood Cells (WBC) protect the body against infections. Platelets are small fractions of cells that in help in blood clotting (coagulation) by accumulating in places of injury, sticking to the lining of an injured blood vessel and forming a base on which blood coagulation would occur. Plasma is the liquid part of blood holding cellular components in suspension. The function of plasma is to transport blood cells along with nutrition, antibodies, clotting proteins and hormones throughout the body.

Whole blood from a donor is obtained at body temperature and collected into cooled, internally sterilized, hermetically sealable plastic bags. These bags typically contain anticoagulants to prevent clotting. During transport, whole blood can typically withstand a temperature of 20 to 24° C. for a maximum of about 6 hours. When collected, blood is placed is directly placed into a well-insulated container capable of cooling the temperature of the blood below 10° C., and maintaining the temperature for a maximum transportation time of 24 hrs.

There are different blood products/components, which each have different temperature requirements. Specific temperature requirements for various components are as listed below:

| | |
|---|---|
| Whole blood | 20 to 24° C. |
| Red Blood Cells (RBCs) | 2 to 6° C. |
| Platelets | less than or equal to 20 to 24° C. |
| Fast Frozen Plasma | less than or equal to −30° C. |
| Cryoprecipitate | less than or equal to −30° C. |

In practice, the product/payload temperature in insulated containers is often generally warmer or cooler by a few degrees.

There are different criteria for shipping and storage. Red blood cells have to be stored at 2 to 6° C., with a shelf life of 35 days. Most of the anticoagulants and nutrients in whole blood are removed by centrifugation. Red cells are suspended in saline, using additive solutions to enhance storage/shelf life. If red cells freeze, the cell membranes rupture, releasing hemoglobin. The resulting blood could be fatal to the patient if transfused. Accordingly, blood must be kept no lower than around 2° C. to avoid freezing. If blood is stored above 6° C., any bacteria that might have entered during collection can proliferate, and the blood could be fatal to the recipient. Accordingly, temperature control during storage is critical.

Platelet concentrates should be stored at room temperature (i.e., between around 20 and around 24° C.), preferably with continuous agitation, to retain viability. Storage at room temperature poses a risk of bacterial growth, and for this reason, the shelf life of platelets is around 7 days, preferably less than 5 days, to minimize bacterial growth.

Fast Frozen Plasma (FFP) is obtained by separating plasma from whole blood within 6-8 hours of collection, maintained at 2 to 6° C., then frozen within 30 minutes. FFP is maintained at less than or equal to −20° C., optimally <=−30° C. with shelf life of 3 years. FFP can be stored even up to 7 years in temperature at <=−65° C.

Cryoprecipitate is the insoluble part of plasma after FFP has been extracted, and is used to correct coagulation defects. The storage temperature requirement is less than or equal to −25° C., with a shelf life of 36 months.

Plasma derivatives like albumin and immunoglobulin are concentrated specific proteins obtained from plasma fractionation, and used to treat patients with specific deficiencies. They are to be stored at 2 to 8° C. without freezing.

The PCM composite materials described herein can be used to maintain these temperatures during shipping and storage. In one embodiment, before a PCM composite material is prepared, for a given shipping and/or storage application, a “temperature profile analysis” is conducted to determine the most appropriate handling, temperature and transport time for the product being shipped and/or stored. Based on this analysis, using the teachings in the specification, one of skill in the art can select an appropriate PCM composite material to keep the material at a desired temperature for a desired length of time. A temperature profile analysis can be a very important component of a validated packaging system.

In one embodiment, the composite material is packed into a sealed package. One or more sealed packages are placed inside a container, such as a cooler, to maintain the contents of the cooler at a relatively constant temperature. The size of the packages can vary, but is typically between about 3 and about 24 ounces, more typically, between about 3 and about 18 ounces.

In another embodiment, the composite material forms all or part of one or more walls of the container. For example, an insulated wall, such as a Styrofoam® wall, can include an internal layer of the composite material, or a layer of the composite material can be adhered to, or positioned adjacent to, a wall.

In another embodiment, the PCM composite material is formed into individual walls (i.e., top, bottom, left, right, front, and back) which connect together to form a box which fits inside a storage/shipping container. For example, FIG. 7 shows an example TES packaging design comprising (1) outer corrugated cardboard box, (2) molded EPS shipper container base, (3) PCM pouches, (4) product box (tertiary container) and (5) molded EPS shipper container lid. [Accessed from Muller, Peter M., “Optical Flow and Deep Learning Based Approach to Visual Odometry” (2016). Thesis. Rochester Institute of Technology].

Accordingly, in one aspect of this embodiment, the box is adapted to fit snugly inside the storage/shipping container. In aspects of this embodiment, the individual walls can be connected together using mechanical connections (i.e., Velcro®, tape, dovetail joints, mortise and tenon joints, finger joints, magnets, hinges, and combinations thereof. The box can also include a rack, such as test tube rack, for storing the various materials to be shipped. The box can also optionally include an outer insulating layer to significantly limit the transfer of thermal energy, hot or cold, to the inside of the box.

In one embodiment, the biological material being shipped is a vaccine. As part of the WHO prequalification scheme, vaccine manufacturers are expected to ensure their packaging complies with the criteria specified below:

Class A packaging: The vaccine must be packed to ensure that the warmest temperature inside the insulated package does not rise above +8° C. in continuous outside ambient temperatures of +43° C. for a period of at least 48 hours.

To achieve this level of temperature control, one can, for example, take a sealed package with a PCM that undergoes a phase change at 5° C., and cool it to a temperature below the temperature at which the phase change occurs, for example, to 2° C., at which temperature all of the PCM is solidified. As the PCM absorbs heat, the temperature goes from 2° C. to 5° C. without undergoing a phase change, and then absorbs additional thermal energy while it undergoes a phase change.

Class B packaging: The vaccine must be packed to ensure that the warmest temperature inside the insulated package does not rise above +30° C. in continuous outside ambient temperatures of +43° C. for a period of at least 48 hours. In this embodiment, one can select a package with a PCM that undergoes a phase change at a temperature between around 20 and 25° C., for example, and cool the material to a lower temperature, for example, around 15° C.

Class C packaging: The vaccines must be packed to ensure that:

a) the warmest temperature inside the insulated package does not rise above 30° C. in continuous outside ambient temperatures of 43° C. for a period of at least 48 hours, and

b) the coolest temperature does not fall below 2° C. in continuous outside ambient temperatures of −5° C., over the same time period.

Pharmaceutical companies are under increased pressure to understand carrier ambient environments in order to develop or justify their transportation method and risk mitigation plan. Pharma companies are also finding a greater need to optimize the product carton and shipping carton, to minimize unused space, and select more precise packaging configurations. An increased number of pharmaceutical companies are also innovating and collaborating with reputable third-party logistics (3PLs) to create better efficiencies, de-bulk shipments and reduce dimensional weight costs.

As cold-chain packaging and shipping trends evolve, pharmaceutical manufacturers will continue to move toward more secure temperature-sensitive shipping solutions, particularly during new last-mile transportation. Shippers are taking advantage of more complete protection of payloads end-to-end, as well as leveraging data from their carriers, such as ambient temperature environment, package orientations, etc. to develop more effective last-mile solutions. For small packages—but particularly for freight—that means more controlled-room temperature (CRT) solutions requiring enhanced ambient environments.

New phase change material (PCM)s are improving pack-out efficiencies with higher latent heat. However, cost is still an issue to further advance the application of such technology. Furthermore, the use of thermal blankets in freight shipments is offering cost-effective protection for previously unprotected products. Even when it comes to manufacturer sales representatives' product samples, there previously was less protection than there is today. Providing the right temperature controls from car to cooler to glove compartment have evolved, as more focus on product protection expand beyond distribution of samples into last-mile deliveries.

Also, complexities that persist include intermodal transportation, which impacts pharmaceutical packaging. Extended time in transit on inland transportation movements exposes the packaging to temperature fluctuations, increasing risk. Ocean transportation increases risks through container placement on the vessel, sunlight exposure, container insulation, and dwell time on the dock, all introducing additional packaging stressors.

Pharmaceutical companies are under increased pressure to understand carrier ambient environments in order to develop or justify their transportation method and risk mitigation plan. Pharma companies are also finding a greater need to optimize the product carton and shipping carton, to minimize unused space, and select more precise packaging configurations. You'll see more efforts placed on sustainable materials, and demand will grow for carriers to offer more temperature controls within its network to minimize packout complexities, costs and requirements. An increased number of pharmaceutical companies are also innovating and collaborating with reputable 3PLs to create better efficiencies, de-bulk shipments and reduce dimensional weight costs.

Styrofoam and water-based PCM are still in high demand, while polyurethane demand is declining, since it is not recyclable and heavier than Styrofoam. Pharma companies are finding a greater need to optimize the product carton and shipping carton, to minimize unused space, and select more precise packaging configurations. You'll see more efforts placed on sustainable materials, and demand will grow for carriers to offer more temperature controls within its network to minimize pack-out complexities, costs and requirements.

The healthcare industry is challenged to do more with less, and the question of where to invest and what to outsource is a lofty, necessary analysis for any effective business strategy. Firms that focus on core competencies and free up capital reserved for logistical assets have the opportunity to leverage collaborative solutions needed to face supply chain challenges such as cost management, regulatory compliance, product security, mitigating product damage and spoilage, and gaining better inventory visibility. Efficient use of PCMs will result in smaller, lighter (reduced freight) thermal packaging designs.

Food Storage/Transportation

The composite materials described herein can be used to ship ice creams, milk, frozen foods, beverages, flowers and horticulture, poultry, meat & seafood, fruits and vegetables, while these items are maintained at an appropriate temperature. As with the uses to transport and store medical and biological products, the composite materials described herein can similarly be present in shipping/storage devices used for these products. Further, larger “walls” of the composite materials can be present in domestic and commercial refrigerators, refrigerated vans, refrigerated trucks, refrigerated sections of airplanes, and the like.

Where food, such as pizza, is intended to be delivered while still warm, the same PCMs used to maintain the medical and biological products at their incubation temperatures, or similar PCMs, can be used to keep food warm while in transit, and, in some embodiments, to cook food while in transit.

Building Materials Incorporating Phase Change Composite Materials

The composite materials described herein can be used in various building materials.

When used in building materials, the PCM is preferably selected to phase transition at a temperature of between 15 and 30° C., more preferably between around 20 and around 25° C., and most preferably at around 23° C.

In one embodiment, an insulating material is prepared by sandwiching the composite materials described herein between two or more layers of an insulating foam, such as polyethylene foam, polyurethane foam, polyvinyl chloride foam, styrofoam, polyimide foam, silicone foam, or microcellular foam, or fiberglass, or both. In one aspect of this embodiment, flexible reflective layers, such as aluminum foil, is present on the outer surface of one of the foam/fiberglass layers.

In another embodiment, the material is present in ceiling tiles, flooring tiles, rolls of flooring material, or as part of floor heating systems.

Clothing/Textiles/Mattresses/Pillows Including the Composite Material

Various textiles can be adapted to receive the composite materials described herein.

In some embodiments, it is desirable to maintain a relatively cool body temperature when individuals are exposed to high temperatures. When ice or gel packs are used, the wearer can be exposed to overly cool temperatures when these ice or gel packs are placed into contact with the skin. In contrast, by selecting an appropriate PCM, the composite materials maintain a desirable temperature, for example, a temperature between about 12 and about 25° C., preferably between about 15 and about 22° C.

In one aspect of this embodiment, the clothing is in the form of a vest, jacket, or long or short-sleeved shirt, which can optionally include one or more additional components, such as straps, for example, on the sides and over the shoulders, to adjust the fit of the vest, zippers, and one or more pockets. In some aspects, the clothing is adapted for use by humans, and in other aspects, for pets such as dogs and cats.

In another aspect, the composite material is present in a layer in a scuba suit, to help maintain body temperature when divers are exposed to cold temperatures.

In another embodiment, the composite materials are present in one or more layers in a mattress and/or pillow, so that when a user is sleeping, and body heat would otherwise heat the mattress and/or pillow, the temperature of the mattress and/or pillow does not change until the phase change is complete. When the user is not sleeping, and thus not adding thermal energy in the form of body heat, the phase change material can cool down.

In one aspect, the clothing itself does not include a layer of the PCM composite materials described herein, but includes pockets adapted to receive a packet of the materials.

HVAC Applications

When used in conjunction with conventional HVAC systems, the composite materials can provide effective thermal management through programmed temperature maintenance.

In one embodiment, the composite materials described herein can be used to provide backup protection from excess heat, for example, in computer cold rooms or telecom cabins, for situations where the excess heat is normally controlled using air conditioning, but the power has gone out.

In one aspect of this embodiment, panels of the composite materials described herein, for example, HDPE panels, are lined against one or more walls in a computer cold room or telecom cabin to maintain the temperature, for example, between about 20 and about 25° C.

In another aspect, panels are lined up on a rack, and a fan is placed over the panels. The fan circulates air over the panels, and heat transfer cools the air, allowing one to cool a room without using an air conditioner. The fan can be battery powered, in addition to or in place of being powered by alternating current, thus allowing the panels to cool a room even when the power is out.

In another aspect, multilayer pouches and pads can be used within central air conditioning ducts and/or false roofing of commercial complexes to help maintain an appropriate temperature.

Boiler and Power Plants Applications

Boilers and power plants typically operate at relatively high temperatures. Power is typically generated by producing steam, and the steam powers a turbine, which in turn generates electricity. The energy below 100° C. is normally wasted. If stored, this energy can be used to pre-heat the media essential for boiler and power plants, heating swimming pool water, and domestic water. This saves energy, and, therefore, the cost of operating this equipment.

Accordingly, in one embodiment, this excess heat is transferred to a PCM composite as described herein, which is then placed in (direct or indirect) contact with a fluid that needs to be heated. In one aspect of this embodiment, spherical balls that encapsulate the PCM composite material are used in boilers, solar water heaters, room heaters, and the like.

Solar Water Heaters

Solar water heaters work during the daytime, using solar energy to raise the water temperature. Even in insulated tanks, elevated temperatures are not retained for long. However, by using a supporting jacket lining comprising the PCM composite materials around the tank, or placing objects including the PCM composite materials, such as spherical balls, inside the tank, one can retain this heat energy for a significantly longer period of time, thus ensuring access to hot water well after sunset.

Heating/Cooling Pads and other Medical Applications

The PCM composite materials described herein can be used in heating/cooling pads to create a dry warm or cold compress, without the risks of hypothermia or burning. The melting point is picked at a temperature that efficiently cools but is too high for causing undesired side effects. This makes PCM the optimal basis for cooling applications for example after surgery or for accident care.

In some embodiments, these can be used much like the clothing embodiments to keep a user warm or cool in overly cold or hot environments. In other embodiments, these can be used to treat injuries or discomfort, and can be appropriately sized and shaped for use at specific areas of the body, such as the shoulder, knee, ankle, elbow, hand, wrist, and the like. Heat therapy can be used treat sub-acute and chronic rheumatic conditions, post-acute conditions after traumas of the musculoskeletal system, or functional disorders of the circulation system.

Further, when a child is born with a brain injury, it is often recommended to cool the brain down for a period of several days. This can be accomplished by wrapping a portion of the baby's head with a wrap that comprises the PCM composite material described herein, with the PCM selected to undergo a phase change around the same temperature at which the brain is to be cooled. In the medical area, PCM can be used for very different applications, some examples will be given here. The use of PCM for the temperature control of drugs, vaccines, etc. during transport will not be addressed because of the more detailed information in the section transport/logistics.

The PCM composite materials can also be used in blankets and sleeping bags to prevent the body from hypothermia. This is important in preparation for surgery or premature baby care for example where passive means for temporary temperature control are preferred.

The PCM composite materials can also be used to increase the wearing comfort of orthoses and prostheses. The materials can reduce perspiration where limb and orthosis/prosthesis are connected, particularly where a PCM with a melting point close to body temperature is used to delay a temperature increase over a relatively long period of time.

Solar thermal energy storage applications are also feasible where PCMs with higher melting temperatures can be used to store heat during the day and then be used to keep the environment warm later. Electro-heating may be possible as well as oppose to solar heating of the PCM composite materials. Since the nanosponge is electronically conductive it will generate heat when a voltage is applied and the heat will be transferred to the PCM material trapped in the pores of the nanosponge storing the thermal energy for later use.

The present invention will be better understood with reference to the following non-limiting examples.

The examples provided herein are to more fully illustrate some of the embodiments of the present invention. It should be appreciated by those of skill in the art that the techniques disclosed in the examples which follow represent techniques discovered by the inventors to function well in the practice of making the materials described herein, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### REFERENCES

Further references in the field of the present invention include:
U.S. Pat. No. 8,080,199, entitled “Interaction of microwaves with carbon nanotubes to facilitate modification,” issued Dec. 20, 2011, to Tour et al. (“Tour '199 Patent”).
U.S. Pat. No. 7,931,884, entitled “Welding of carbon single-walled nanotubes by microwave treatment,” issued Apr. 26, 2011, to Harutyunyan et al. (“Harutyunyan '884 Patent”).
U.S. Pat. No. 7,879,940, entitled “Polymerization initiated at sidewalls of carbon nanotubes,” issued Feb. 1, 2011, to Tour et al. (“Tour '940 Patent”).
U.S. Pat. No. 7,459,137, entitled “Process for functionalizing carbon nanotubes under solvent-free conditions,” issued Dec. 8, 2008, to Tour et al. (“Tour '137 Patent”).
U.S. Pat. No. 7,304,103, entitled “Process for making polymers comprising derivatized carbon nanotubes and compositions thereof,” issued Dec. 4, 2007, to Tour et al. (“Tour '103 Patent”).
U.S. Pat. No. 7,250,147, entitled “Process for derivatizing carbon nanotubes with diazonium species,” issued Jul. 31, 2007, to Tour et al. (“Tour '147 Patent”).
U.S. Pat. No. 7,125,533, entitled “Method for functionalizing carbon nanotubes utilizing peroxides,” issued Oct. 24, 2006, to Khabashesku et al. (“Khabashesku '533 Patent”).
U.S. Pat. No. 7,105,596, entitled “Methods for producing composites of single-wall carbon nanotubes and compositions thereof,” issued Sep. 12, 2006, to Smalley et al. (“Smalley '596 Patent”).
U.S. Pat. No. 7,067,098, entitled “Method for forming an array of single-wall carbon nanotubes and compositions thereof,” issued Jun. 27, 2006, to Colbert et al. (“Colbert '098 Patent”).
U.S. Pat. No. 6,645,455, entitled “Chemical derivatization of single-wall carbon nanotubes to facilitate solvation thereof; and use of derivatized nanotubes to form catalyst-containing seed materials for use in making carbon fibers,” issued Nov. 11, 2003, to Margrave et al. (“Margrave '455 Patent”).
U.S. Pat. No. 6,495,258, entitled “Structures with high number density of carbon nanotubes and 3-dimensional distribution,” issued Dec. 17, 2002, to Chen et al. (“Chen '258 Patent).
U.S. Pat. No. 5,252,215, entitled “Absorbent materials and use thereof,” issued Oct. 12, 1993, to McFarlane et al. (“McFarland '215 Patent”).
Blase, X., et al., “Boron-Mediated Growth of Long Helicity-Selected Carbon Nanotubes,” Phys. Rev. Lett., 1999, 83, 5078-5081 (“Blase 1999”).
Burgess, J. S., et al., “Boron-doped carbon powders formed at 1000° C. and one atmosphere, Carbon, 2008, 46, 1711-1717 (“Burgess 2008”).
Carroll, D. L., et al., “Effects of Nanodomain Formation on the Electronic Structure of Doped Carbon Nanotubes,” Phys. Rev. Lett., 1998, 81, 2332-2335 (“Carroll 1998”).
Cermignani, W., et al., “Synthesis and characterization of boron doped carbons,” Carbon, 1995, 33, 367-374 (“Cermignani 1995”).
(Dunlap, B. I., “Connecting carbon tubules,” Phys. Rev. 13, 1992, 46, 1933-1936 (“Dunlap 1992”).
Endo, M., et al., “Atomic Nanotube Welders: Boron Interstitials Triggering Connections in Double-Walled Carbon Nanotubes,” Nano Lett., 2005, 5, 1099-1105 (“Endo 2005”).
Froudakis, G. E., “Hydrogen storage in nanotubes & nanostructures,” Materials today, 2011, 14, 324-328 (“Froudakis 2011”).
Gogotsi, Y., “High-Temperature Rubber Made from Carbon Nanotubes,” Science, 2010, 330, 1332-1333 (“Gogotsi 2010”).
Goldberg, D., et al., “Single-walled B-doped carbon, B/N-doped carbon and BN nanotubes synthesized from single-walled carbon nanotubes through a substitution reaction,” Chem. Phys. Lett., 1999, 308, 337-342 (“Goldberg 1999”).
Gui, X., et al., “Soft, Highly Conductive Nanotube Sponges and Composites with Controlled Compressibility, ACS Nano, 2010, 4, 2320-2326 (“Gui I 2010”).
Gui X., et al, “Carbon Nanotube Sponges,” Adv. Mater., 2010, 22, 617-621 (“Gui II 2010”). Han, W. Q., et al., “Aligned CNx nanotubes by pyrolysis of ferrocene/C₆₀ under NH₃ atmosphere,” Appl. Phys. Lett., 2000, 77, 1807-1810 (“Han 2000”).
Iijima, S., “Helical Microtubules of Graphitic Carbon” Nature, 1991, 354, 56-58 (“Iijima 1991”).
Jacobsohn, L. G., et al., “X-ray photoelectron spectroscopy investigation of boron carbide films deposited by sputtering,” Surf. Sci., 2004, 572, 418-424 (“Jacobsohn 2004”)
Koos, A. A., et al., “Comparison of Structural changes in nitrogen and boron-doped multi-walled carbon nanotubes,” Carbon, 2010, 48, 3033-3041 (“Koos 2010”).
Kresse, G., et al., “Efficient iterative schemes for ab initio total-energy calculations using a plane-wave basis set,” Phys. Rev. B, 1996, 54, 11169-11186 (“Kresse 1996”).
Kurt, R., et al., “Tailoring the diameter of decorated C—N nanotubes by temperature variations using HF-CVD,” Carbon, 2001, 39, 2163-2172 (“Kurt 2001”).
Lee, C. J., et al., “Synthesis of bamboo-shaped carbon-nitrogen nanotubes using C₂H₂—NH₃—Fe(CO)₅ system,” Chem. Phys. Lett., 2002, 359, 115-120 (“Lee 2002”).
Lehman, J. H., et al., “Evaluating the characteristics of multiwall carbon nanotubes,” Carbon, 2011, 49, 2581-2602 (“Lehman 2011”).
Li, S., et al., “Super-Hydrophobicity of Large-Area Honeycomb-Like Aligned Carbon Nanotubes,” J. Phys. Chem. B, 2002, 106, 9274-9276 (“Li 2002”).
Liu, Y. S., et al., “Effect of deposition temperature on boron-doped carbon coatings deposited from a BCl₃—C₃H₆—H₂ mixture using low pressure chemical vapor deposition,” Appl. Surf Sci., 2009, 255, 8761-8768 (“Liu 2009”).
Lozano-Castello, D., et al., “Preparation and characterisation of novel ‘sea-cucumber’-like structures containing carbon and boron,” Carbon, 2004, 42, 2223-2231 (“Lozano-Castello 2004”).
Lyu, S. C., et al., “Synthesis of boron-doped double-walled carbon nanotubes by the catalytic decomposition of tetrahydrofuran and triisopropyl borate,” Carbon, 2011, 49, 1532-1541 (“Lyu 2011”).
Ma, X., et al., “Polymerized carbon nanobells and their field emission properties,” Appl. Phys. Len., 1999, 75, 3105-3108 (“Ma 1999”).
Maultzsch, J., et al., “Raman characterization of boron-doped multiwalled carbon nanotubes,” Appl. Phys. Lett., 2002, 81, 2647-2650 (“Maultzsch 2002”).
McGuire, K., et al., “Synthesis and Raman characterization of boron-doped single-walled carbon nanotubes,” Carbon, 2005, 43, 219-217 (“McGuire 2005”).
Mondal, K. C., et al., “Boron mediated synthesis of multiwalled carbon nanotubes by chemical vapor deposition,” Chem. Phys. Lett., 2007, 437, 87-89 (“Mondal 2007”).
Nath, M., et al., “Production of bundles of aligned carbon and carbon-nitrogen nanotubes by the pyrolysis of precursors on silica-supported iron and cobalt catalyst,”. Chem. Phys. Lett, 2000, 322, 333-340 (“Nath 2000”).
Oberlin, A., et al, “Filamentous growth of carbon through benzene decomposition,” Journal of Crystal Growth, 1976, 32, 335-349 (“Oberlin 1976”).
Redlich, P., et al., “B—C—N nanotubes and boron doping of carbon nanotubes,” Chem. Phys. Lett, 1996, 260, 465-470 (“Redlich 1996”).
Perdew, J. P., et al., “Generalized gradient approximation made simple,” Phys. Rev. Lett., 1996, 77, 3865-3868 (“Perdew 1996”).
Romo-Herrera, J. M., et al., “The Role of Sulfur in the synthesis of Novel Carbon Morphologies: From Covalent Y-Junctions to Sea-Urchin-Like Structures,” Adv. Func. Mater., 2009, 19, 1193-1199 (“Romo-Herrera 2009”).
Romo-Herrera, J. M., et al., “An atomistic branching mechanism for carbon nanotubes: Sulfur as the triggering agent,” Angewandte Chemie, 2008, 47, 2948-2953 (“Romo-Herrera 2008”).
Romo-Herrera, J. M., et al., “Covalent 2D and 3D networks from 1D nanostructures: designing new materials,” Nano Lett, 2007, 7, 570-576 (“Romo-Herrera 2007”)
Sen, R., et al., “B—C—N, C—N and B—N nanotubes produced by the pyrolysis of precursor molecules over Co catalyst,” Chem. Phys. Lett., 1998 287, 671-676 (“Sen 1998”).
Sen, R., et al., “Nitrogen-containing carbon nanotubes,” J. Mater. Chem., 1997, 7, 2335-2337 (“Sen 1997”).
Shirasaki, T., et al., “Synthesis and characterization of boron-substituted carbons,” Carbon, 2000; 38, 1461-1467 (“Shirasaki 2000”)
Stephan O., et al., “Doping graphitic and carbon nanostructures with boron and nitrogen,” Science, 1994, 266, 1683-1685 (“Stephan 1994”).
Singh, A. K., et al., “Metallacarboranes: Towards Promising Hydrogen Storage Metal Organic Frameworks,” J. Am. Chem. Soc., 2010, 132, 14126-14129 (“Singh 2010”).
Suenaga, K., et al., “Radially modulated nitrogen distribution in CNx nanotubular structures prepared by CVD using Ni phthalocyanine,” Chem. Phys. Lett., 2000, 316, 365-372 (“Suenaga 1997”).
Suenaga, K., et al., “Synthesis of Nanoparticles and Nanotubes with Well-Separated Layers of Boron Nitride and Carbon,” Science, 1997, 278, 653-655 (“Suenaga 1997”).
Sumpter, B. G., et al., “A Theoretical and Experimental Study On Manipulating the Structure and Properties of Carbon Nanotubes Using Substitutional Dopants,” International Journal of Quantum Chemistry, 2009, 109, 97-118 (“Sumpter 2009”).
Sumpter, B. G., et al., “Nitrogen-Mediated Carbon Nanotube Growth: Diameter Reduction, Metallicity, Bundle Dispersability, and Bamboo-like Structure Formation,” ACS Nano, 2007, 1, 369-375 (“Sumpter 2007”).
Terrones, M., et al., “Efficient route to large arrays of CNx nanofibers by pyrolysis of ferrocene/melamine mixtures,” Appl. Phys. Lett., 1999, 75, 3932-3925 (“Terrones 1999”).
Terrones, M., et al., “Pyrolytically grown BxCyNz nanomaterials: nanofibres and nanotubes,” Chem. Phys. Lett, 1996, 257, 576-582 (“Terrones 1996”).
Wang, X., et al., Controllable Growth, Structure, and Low Field Emission of Well-Aligned CNx Nanotubes. J. Phys. Chem. B 2002, 106, 2186-2190 (“Wang 2002”).
Wu, X., et al., “Inhibition of catalytic oxidation of carbon/carbon composites by boron-doping,” Carbon, 2005, 43, 1768-1777 (“Wu 2005”).
Xu, M., et al., “Carbon Nanotubes with Temperature-Invariant Viscoelasticity from −196° to 1000° C.,” Science, 2010, 330, 1364-1368 (“Xu 2010”).
Yang, L. et al., “Boron-doped carbon nanotubes as metal-free electrocatalysts for the oxygen reduction reaction,” Angewandte Chemie-International Ed., 2011, 50, 7132-7135 (“Yang 2011”).
Yi, J.-Y., et al., “Atomic Structure and doping of microtubules,” Phys. Rev. B, 1993, 47, 1708-1711 (“Yi 1993”).
Yudasaka, M., et al., “Nitrogen-containing carbon nanotube growth from Ni phthalocyanine by chemical vapor deposition,” Carbon, 1997, 35, 195-201 (“Yudasaka 1997”).

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

1. A composite material comprising a phase change material and a macroscale 3D carbon nanostructure porous foam material.

2. The composite material of claim 1, wherein the macroscale 3D carbon nanostructure porous foam material comprises carbon nanotubes and/or graphene.

3. (canceled)

4. The composite material of claim 2, wherein the macroscale 3D carbon nanostructure porous foam material comprises carbon nanotubes, and the carbon nanotubes are heteroatom-doped carbon nanotubes.

5. The composite material of claim 4, wherein the macroscale 3D heteroatom-doped carbon nanotube material is formed by a process comprising:
a) forming a chemical precursor comprising a carbon source, a catalyst source, and a heteroatom source;
b) generating an aerosol or vapor from the chemical precursor; and
c) performing a chemical vapor deposition process using the aerosol or vapor to form the macroscale 3D heteroatom-doped carbon nanotube material, wherein the macroscale 3D heteroatom-doped carbon nanotube material comprises heteroatom-doped carbon nanotubes.

6. The composite material of claim 5, wherein the heteroatom is boron.

7. The composite material of claim 5, wherein the carbon source is at least 78 wt % of the carbon source, the catalyst source, and the heteroatom source in the chemical precursor.

8. The composite material of claim 5, wherein the catalyst source is capable of catalyzing the formation of carbon nanotubes in a chemical vapor deposition process.

9. The composite material of claim 5, wherein the catalyst source comprises a metal catalyst, which comprises a metal selected from the group consisting of iron, nickel, cobalt, and alloys and combinations thereof.

10. The composite material of claim 5, wherein the catalyst source is between about 2.5 wt % and about 12 wt % of the carbon source, the catalyst source, and the heteroatom source in the chemical precursor.

11. The composite material of claim 5, wherein the heteroatom is selected from the group consisting of boron, sulfur, nitrogen, phosphorus, and combinations thereof.

12. (canceled)

13. The composite material of claim 5, wherein the heteroatom source is at most about 2 wt % of the carbon source, the catalyst source, and the heteroatom source in the chemical precursor.

14. The composite material of claim 5, wherein (a) the catalyst source comprises metal atoms; (b) the heteroatom source comprises heteroatoms; and (c) the ratio of the metal atoms to the heteroatoms is between 2 and 20.

15. The composite material of claim 5, wherein the step of forming the chemical precursor may be a solution that comprises: (a) mixing the liquid carbon source, catalyst source, and heteroatom source; and (b) sonicating the mixture of the carbon source, catalyst source and boron.

16. The composite material of claim 5, wherein (a) the aerosol is introduced into a reactor capable of performing the aerosol-assisted chemical vapor deposition process using the aerosol to form the heteroatom-doped carbon nanotube material; and (b) the aerosol is introduced into the reactor via a carrier gas stream.

17. The composite material of claim 5, wherein the carrier gas stream comprises argon or argon/hydrogen balanced gas, which carrier gas stream is introduced into the reactor at a gas flux range between about 0.05 sl/min-cm2 and about 0.6 L/min-cm2.

18. The composite material of claim 5, wherein the aerosol-assisted chemical vapor deposition process is carried out under atmospheric pressure and at a temperature between 800° C. and 900° C.

19. The composite material of claim 5, wherein the method further comprises the step of forming a composite of the macroscale 3D heteroatom-doped carbon nanotube material and a PCM.

20. The composite material of claim 4, wherein the heteroatom-doped carbon nanotube material has a weight-to-weight absorption capacity for the encapsulated PCM between about 22 and 123.

21. The composite material of claim 4, wherein the macroscale 3D heteroatom-doped carbon nanotube material is capable of absorbing a volume of PCM that is between about 70% and about 115% of the volume of the macroscale 3D heteroatom-doped carbon nanotube material before absorption of the solvent.

22. A method of shipping and/or storing food, pharmaceutical and/or medical and/or life science products, comprising:
a) selecting an appropriate PCM for the particular product,
b) encapsulating the PCM in a macroscale 3D carbon nanostructure porous foam material of any of claims 1-22 to form a composite material,
c) cooling the composite material to a temperature below the phase transition temperature of the encapsulated PCM,
d) placing the composite material in a storage container along with the food, pharmaceutical and/or medical and/or life science product to be encapsulated, and
e) shipping and/or storing the food, pharmaceutical and/or medical and/or life science product.

23-38. (canceled)
